(19) United States
(12) Patent Application Publication
(10) Pub. No.: US 2022/0338221 A1
(43) Pub. Date: Oct. 20, 2022

(54) TBS DETERMINATION FOR MULTI-TRP PDSCH TRANSMISSION SCHEMES

(71) Applicant: Telefonaktiebolaget LM Ericsson (publ), Stockholm (SE)

(72) Inventors: Siva Muruganathan, Stittsville (CA); Shiwei Gao, Nepean (CA); Mattias Frenne, Uppsala (SE); Sebastian Faxér, Stockholm (SE)

(21) Appl. No.: 17/634,604

(22) PCT Filed: Aug. 15, 2020
(86) PCT No.: PCT/IB2020/057703

§ 371 Date: Feb. 11, 2022

Related U.S. Application Data
(60) Provisional application No. 62/888,199, filed on Aug. 16, 2019.

(51) Int. Cl. H04W 72/12; H04W 72/04; H04L 1/08

(52) U.S. Cl. CPC H04W 72/1273; H04W 72/0453; H04W 72/042; H04L 1/08

(57) ABSTRACT

Systems and methods for determining Transport Block Size (TBS) are provided. In some embodiments, a method performed by a wireless device for determining (TBS) includes: receiving an indication of the type of Frequency Domain Multiplexing (FDM) scheme from a base station; and applying different rules to determine TBS depending on which type of FDM scheme was indicated. In this way, different rules of how to determine TBS are provided when both flavors (i.e., single codeword-single Redundancy Version (RV) scheme, and multiple codewords-multiple RVs scheme) of FDM schemes are supported by NR Rel-16.

### RELATED APPLICATIONS

This application claims the benefit of provisional patent application Ser. No. 62/888,199, filed Aug. 16, 2019, the disclosure of which is hereby incorporated herein by reference in its entirety.

### TECHNICAL FIELD

The present disclosure relates to determining Transport Block Size (TBS).

### BACKGROUND

The new generation mobile wireless communication system (5G) or new radio (NR) supports a diverse set of use cases and a diverse set of deployment scenarios. NR uses CP-OFDM (Cyclic Prefix Orthogonal Frequency Division Multiplexing) in the downlink (i.e., from a network node, gNB, eNB, or base station, to a user equipment or UE) and both CP-OFDM and Discrete Fourier Transform (DFT)-spread OFDM (DFT-S-OFDM) in the uplink (i.e., from UE to gNB). In the time domain, NR downlink and uplink physical resources are organized into equally-sized subframes of 1 ms each. A subframe is further divided into multiple slots of equal duration.

The slot length depends on subcarrier spacing. For subcarrier spacing of Δf=15 kHz, there is only one slot per subframe and each slot always consists of 14 OFDM symbols, irrespectively of the subcarrier spacing.

Typical data scheduling in NR are per slot basis, an example is shown in FIG. 1 where the first two symbols contain Physical Downlink Control Channel (PDCCH) and the remaining 12 symbols contains Physical Data Channel (PDCH), either a Physical Downlink Data Channel (PDSCH) or Physical Uplink Data Channel (PUSCH).

Different subcarrier spacing values are supported in NR. The supported subcarrier spacing (SCS) values (also referred to as different numerologies) are given by Δf=(15×2^{α}) kHz where α∈(0, 1, 2, 4, 8). Δf=15 kHz is the basic subcarrier spacing that is also used in LTE, the corresponding slot duration is 1 ms. For a given SCS, the corresponding slot duration is

$$\frac{1}{{2}^{α}}$$

ms.

In the frequency domain physical resource definition, a system bandwidth is divided into Resource Blocks (RBs), each corresponds to 12 contiguous subcarriers. The basic NR physical time-frequency resource grid is illustrated in FIG. 2, where only one RB within a 14-symbol slot is shown. One OFDM subcarrier during one OFDM symbol interval forms one Resource Element (RE).

Downlink transmissions can be dynamically scheduled, i.e., in each slot the gNB transmits Downlink Control Information (DCI) over PDCCH about which UE data is to be transmitted to and which RBs and OFDM symbols in the current downlink slot the data is transmitted on. PDCCH is typically transmitted in the first one or two OFDM symbols in each slot in NR. The UE data are carried on PDSCH. A UE first detects and decodes PDCCH and if the decoding is successfully, it then decodes the corresponding PDSCH based on the decoded control information in the PDCCH.

Uplink data transmission can also be dynamically scheduled using PDCCH. Similar to downlink, a UE first decodes uplink grants in PDCCH and then transmits data over PUSCH based the decoded control information in the uplink grant such as modulation order, coding rate, uplink resource allocation, etc.

Reliable data transmission with multiple panels or Transmission reception Points (TRPs) has been proposed in 3GPP for Rel-16, in which a data packet may be transmitted over multiple TRPs to achieve diversity. An example is shown in FIG. 3, where the two PDSCHs carry the same encoded data payload but with the same or different redundancy versions so that the UE can do soft combining of the two PDSCHs to achieve more reliable reception.

Different schemes have been identified for PDSCH transmissions from multiple TRPs, including
SFN (Single Frequency Network) with CDD (Cyclic Delay Diversity)
SDM (Spatial Division Multiplexing)
FDM (Frequency Domain Multiplexing)
TDM (Time Domain Multiplexing)

For SDM and FDM schemes, there are also different sub-schemes depending on whether a codeword (CW) with a single redundancy version is used or multiple CWs each with a different redundancy versions are used in the transmissions. For TDM scheme, there can be slot based or mini-slot based sub-schemes. FIG. 4 illustrates four of these different schemes.

In 3GPP RAN1 #96bis, it was agreed that both slot and mini-slot based TDM schemes will be supported in NR Rel-16, in which PDSCHs in consecutive slots or mini-slots may be transmitted from different TRPs. An example is shown in FIG. 5, where four PDSCHs for a same Transport Block (TB) are transmitted over four TRPs and in four consecutive slots. Each PDSCH is associated with a different Redundancy Version (RV). The RV and TRP associated with each slot can be either preconfigured or dynamically signaled.

FIG. 6 shows an example of an SDM scheme with a single RV in which a PDSCH with two spatial layers, one from each TRP, is transmitted to a UE.

FIG. 7 shows an example of an FDM scheme in which a PDSCH is transmitted in RB #0, 1, 4, 5, 8, 9 from TRP1 and RB #2, 3, 6, 7, 10, 11 from TRP2.

In RAN1 #97 meeting in May 2019, two types of FDM schemes were agreed which are discussed below:
In the first type, a PDSCH with a single RV is transmitted across two TRPs. Using the example of FIG. 7, parts of the coded bits from the circular buffer are transmitted via TRP1 (using RBs 0, 1, 4, 5, 8, and 9) and the other part of the coded bits from the circular buffer are transmitted via TRP2 (using RBs 2, 3, 6, 7, 10, and 11). There is only a single codeword (i.e., single TB) being transmitted in a slot in this case.
In the second type, a PDSCH with two codewords is transmitted across two TRPs. The two codewords correspond to the same TB with different RVs. Using the example of FIG. 7, the first codeword corresponding to a TB with a first RV is transmitted via TRP1 (using RBs 0, 1, 4, 5, 8, and 9) and the second codeword corresponding to the same TB with a second RV is transmitted via TRP2 (using RBs 2, 3, 6, 7, 10, and 11).

In the case of the FDM scheme of the 2^{nd} type, since the two codewords carried by the two TRPs have two different RVs of the same TB, soft combining can be performed by the UE to improve the reliability of receiving the TB. Chase combining (CC) can be performed when the same RV is used in the two TRPs (for instance, a first codeword with RV0 in TRP1 and a second codeword with RV0 in TRP2). Incremental redundancy (IR) based soft combining can be done when different RVs are used (for example, a first codeword with RV0 in TRP1 and a second codeword with RV1 in TRP2).

Several signals can be transmitted from the same base station antenna from different antenna ports. These signals can have the same large-scale properties, for instance in terms of Doppler shift/spread, average delay spread, or average delay. These antenna ports are then said to be quasi co-located (QCL).

The network can then signal to the UE that two antenna ports are QCL. If the UE knows that two antenna ports are QCL with respect to a certain parameter (e.g., Doppler spread), the UE can estimate that parameter based on one of the antenna ports and use that estimate when receiving the other antenna port. Typically, the first antenna port is represented by a measurement reference signal (known as source RS) such as CSI-RS (Channel State Information RS) and the second antenna port is a Demodulation Reference Signal (DMRS) (known as target RS). This is useful for demodulation since the UE can know beforehand the properties of the channel when doing channel estimation with DMRS.

Information about what assumptions can be made regarding QCL is signaled to the UE from the network. In NR, four types of QCL relations between a transmitted source RS and transmitted target RS were defined:
Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced to facilitate beam management with analog beamforming and is known as spatial QCL. There is currently no strict definition of spatial QCL, but the understanding is that if two transmitted antenna ports are spatially QCL, the UE can use the same Rx beam to receive them.

Transmission Configuration Indicator (TCI) states: For dynamic indication of PDSCH transmission over different TRPs or beams, a UE can be configured through Radio Resource Control (RRC) signaling with a list of N TCI states, where Nis up to 128 in frequency range 2 (FR2) and up to eight in FR1, depending on UE capability.

Each TCI state contains QCL information, i.e., one or two source DL RSs, each source RS associated with a QCL type. The list of TCI states can be interpreted as a list of N possible TRPs or beams that may be used by the network to transmit PDSCH to the UE.

The network can activate up to eight active TCI states. For a given PDSCH transmission, the associated active TCI state(s) is dynamically signaled in the TCI field of DCI in the corresponding PDCCH scheduling the PDSCH. In NR Rel-15, only one TCI state can be indicated. It has been agreed that up to two TCI states can be indicated in DCI in NR Rel-16. The TCI state(s) indicates which TRP(s) the PDSCH is transmitted from.

Frequency Domain Resource allocation in NR: Rel-15 NR supports two types of downlink frequency domain resource allocations which are described below:

Downlink resource allocation type 0: In downlink resource allocation type 0, a bitmap in the ‘Frequency domain resource assignment’ DCI field indicates the resource block groups (RBGs) that are allocated to the scheduled UE. An RBG consists of a set of consecutive Virtual Resource Blocks (VRBs), and the RBG size can be configurable by higher layers. As shown in Table 5.1.2.2.1-1 below, two configurations are possible for the RBG size and the RBG size depends on the bandwidth part size. For resource allocation type 0, the number of bits included in the ‘Frequency domain resource assignment’ field is N_{RBG}, wherein N_{RBG} is the number of RBGs in the bandwidth part the UE is being scheduled on. The number of RBGs in the P bandwidth part with size N_{BWP,i}^{size} is defined as

N_{RBG}=┌(N_{BWP,i}^{size}+(N_{BWP,i}^{start} mod P))/P┐

where N_{BWP,i}^{start} is the starting PRB of the i^{th} bandwidth part and P is the RBG size given in

TABLE 5.1.2.2.1-1
Downlink Resource allocation type 1 is used in DCI format 1_1.
Table 5.1.2.2.1-1: Nominal RBG size P (extracted from 3GPP TS 38.214)

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

Downlink resource allocation type 1: In downlink resource allocation type 1, the ‘Frequency domain resource assignment’ DCI field indicates a set of contiguously allocated non-interleaved or interleaved virtual resource blocks within the active bandwidth part to the scheduled UE. The ‘Frequency domain resource assignment’ field includes the Resource Indication Value (RIV) which represents the starting VRB (RBₛₜₐᵣₜ) and the length of the contiguously allocated resource blocks denoted by L_{RBs}. The number of bits in ‘Frequency domain resource assignment’ field is ┌log₂ (N_{RB}^{DL,BWP}(N_{RB}^{DL,BWP}+1)/2)┐ wherein N_{RB}^{DL,BWP} is the size of the active bandwidth part. Downlink Resource allocation type 1 is used in both DCI formats 1_0 and 1_1.

In NR Rel-15, it is possible for both resource allocation type 0 and type 1 to be configured. In this case, the number of bits in the ‘Frequency domain resource assignment’ DCI field is max (log₂ (N_{RB}^{DL,BWP}(N_{RB}^{DL,BWP}+1)/2)┐, N_{RBG})+1. Here, the most significant bit (MSB) indicates whether resource allocation type 0 is used or resource allocation type 1 is used. A MSB value of 1 indicates that resource allocation type 1 is used while MSB value of 0 indicates that resource allocation type 0 is used.

TBS determination in Rel-15 NR: In Rel-15 NR, the TB size (TBS) is determined in the following way:
First, calculate an intermediate number of information bits via N_{info}=ν·Qₘ·R·n_{PRB}·N̅_{RE}, where
   ν is the number of spatial layers transmitted per codeword (which can be up to 4 in NR)
   Qₘ is the modulation order, obtained from the MCS index indicated in DCI
   R is the code rate, obtained from the MCS index indicated in DCI
   n_{PRB} is the total number of allocated PRBs determined from the scheduling DCI
   N̅_{RE} is the number of available REs in a PRB
If N_{info}≤3824, a look-up table is used to determine TBS. In this case, first quantize N_{info} as

$${N}_{info}^{′} = max ( 24 , {2}^{n} \cdot ⌊ \frac{{N}_{info}}{{2}^{n}} ⌋ )$$

where n=max(3, └log₂ N_{info}┘−6). The TBS is then determined by finding the closest TBS to N′_{info} that is less than N′_{info} from the look-up table. The look up table define in NR Rel-15 is given below with the allowed TBSs when N_{info}≤3824:

TABLE 2-1
Look-up table specified in NR Rel-15 for determining
TBS when N_{info} ≤ 3824
Lookup Table for Small TBS

| | | | | | | | |
|---|---|---|---|---|---|---|---|
| 24 | 120 | 240 | 456 | 808 | 1288 | 2024 | 2856 |
| 32 | 128 | 256 | 480 | 848 | 1320 | 2088 | 2976 |
| 40 | 136 | 272 | 504 | 88 | 1352 | 2152 | 3104 |
| 48 | 144 | 288 | 528 | 928 | 1416 | 2216 | 3240 |
| 56 | 152 | 304 | 552 | 984 | 1480 | 2280 | 3368 |
| 64. | 160 | 320 | 576 | 1032 | 1544 | 2408 | 3496 |
| 72 | 168 | 336 | 608 | 1064 | 1608 | 2472 | 3624 |
| 80 | 176 | 352 | 640 | 1128 | 1672 | 2536 | 3752 |
| 88 | 184 | 368 | 672 | 1160 | 1736 | 2600 | 3824 |
| 96 | 192 | 384 | 704 | 1192 | 1800 | 2664 | |
| 104 | 208 | 408 | 736 | 1224 | 1864 | 2728 | |
| 112 | 224 | 432 | 768 | 1256 | 1928 | 2792 | |

If N_{info}>3824, a formula defined in the specifications is used to determine TBS. In this case, first quantize N_{info} as

$${N}_{info}^{′} = {2}^{n} \cdot round ( ⌊ \frac{{N}_{info} - 24}{{2}^{n}} ⌋ )$$

where n=└log₂(N_{info}−24)┘−5. The number of code blocks is next calculated using the following formula:

$$C = \{ \begin{matrix}1 & if {N}_{info}^{′} + 24 \leq {K}_{s} \\ ⌈ \frac{{N}_{info}^{′} + 24}{{K}_{s} - 24} ⌉ & otherwise\end{matrix}$$

where Kₛ=3840 if code rate R≤1/4; otherwise, Kₛ=8448. The TBS for this case is then determined using the following formula:

$$T B S = 8 C \cdot ⌈ \frac{{N}_{info}^{′} + 24}{8 C} ⌉ - 24$$

Demodulation Reference Signals (DMRS) are used for coherent demodulation of physical layer data channels, PDSCH (downlink (DL)) or PUSCH (uplink (UL)). The DM-RS is confined to resource blocks carrying the associated physical layer channel and is mapped on allocated resource elements of the OFDM time-frequency grid such that the receiver can efficiently handle time/frequency-selective fading radio channels.

The mapping of DM-RS to resource elements is configurable in both frequency and time domain, with two mapping types in the frequency domain (configuration Type 1 or Type 2). The DM-RS mapping in time domain can be either single-symbol based or double-symbol based where the latter means that DM-RS is mapped in pairs of two adjacent symbols.

FIG. 8 shows an example of front-loaded DM-RS for configuration Type 1 and Type 2 with single-symbol and double-symbol DM-RS. Type 1 and Type 2 differs with respect to both the mapping structure and the number of supported DM-RS CDM (Code Division Multiplexing) groups where type 1 supports 2 CDM groups and Type 2 supports three CDM groups.

The mapping structure of type 1 is sometimes referred to as a 2-comb structure with two CDM groups defined, in frequency domain, by the set of subcarriers {0, 2, 4, . . . } and {1, 3, 5, . . . }.

A DM-RS antenna port is mapped to the resource elements within one CDM group only. For single-symbol DM-RS, two antenna ports can be mapped to each CDM group whereas for double-symbol DM-RS four antenna ports can be mapped to each CDM group. Hence, the maximum number of DM-RS ports for type 1 is either four or eight. The maximum number of DM-RS ports for type 2 is either six or twelve. An orthogonal cover code (OCC) of length 2 ([+1, +1], [+1, −1]) is used to separate antenna ports mapped on same resource elements within a CDM group. The OCC is applied in frequency domain as well as in time domain when double-symbol DM-RS is configured.

In NR Rel-15, the mapping of a PDSCH DM-RS sequence r(m), m=0, 1, . . . on antenna port pⱼ and subcarrier k in OFDM symbol l for the numerology index μ is specified in 3GPP TS38.211 as

$${a}_{k , l}^{( {p}_{j} , μ )} = {β}_{DMRS}^{PDSCH} {r}_{λ}^{( {p}_{j} )} ( 2 n + {k}^{′} )$$

$$k = \{ \begin{matrix}4 n + 2 {k}^{′} + Δ & Configuration type 1 \\ 6 n + {k}^{′} + Δ & Configuration type 2\end{matrix}$$

$${k}^{′} = 0 , 1$$

$$l = \overline{l} + {l}^{′}$$

$$n = 0 , 1 , …$$

$$where$$

$${r}_{λ}^{( {p}_{j} )} ( 2 n + {k}^{′} ) = {w}_{f} ( {k}^{′} ) {w}_{t} ( {l}^{′} ) r ( 2 n + {k}^{′} )$$

represents the reference signal mapped on port pⱼ in CDM group λ after applying OCC in frequency domain, w_{f}(k′), and time domain, wₜ(l′). Table 1 and Table 2 show the PDSCH DM-RS mapping parameters for configuration type 1 and type 2, respectively.

TABLE 2-2
PDSCH DM-RS mapping parameters for configuration type 1.

| | CDM | | w_{f} (k′) | | wₜ (l′) | |
|---|---|---|---|---|---|---|
| p | group λ | Δ | k′ = 0 | k′ = 1 | l′ = 0 | l′ = 1 |
| 1000 | 0 | 0 | +1 | +1 | +1 | +1 |
| 1001 | 0 | 0 | +1 | −1 | +1 | +1 |
| 1002 | 1 | 1 | +1 | +1 | +1 | +1 |
| 1003 | 1 | 1 | +1 | −1 | +1 | +1 |
| 1004 | 0 | 0 | +1 | +1 | +1 | −1 |
| 1005 | 0 | 0 | +1 | −1 | +1 | −1 |
| 1006 | 1 | 1 | +1 | +1 | +1 | −1 |
| 1007 | 1 | 1 | +1 | −1 | +1 | −1 |

TABLE 2-3
PDSCH DM-RS mapping parameters for configuration type 2.

| | CDM | | w_{f} (k′) | | wₜ (l′) | |
|---|---|---|---|---|---|---|
| p | group λ | Δ | k′ = 0 | k′ = 1 | l′ = 0 | l′ = 1 |
| 1000 | 0 | 0 | +1 | +1 | +1 | +1 |
| 1001 | 0 | 0 | +1 | −1 | +1 | +1 |
| 1002 | 1 | 2 | +1 | +1 | +1 | +1 |
| 1003 | 1 | 2 | +1 | −1 | +1 | +1 |
| 1004 | 2 | 4 | +1 | +1 | +1 | +1 |
| 1005 | 2 | 4 | +1 | −1 | +1 | +1 |
| 1006 | 0 | 0 | +1 | +1 | +1 | −1 |
| 1007 | 0 | 0 | +1 | −1 | +1 | −1 |
| 1008 | 1 | 2 | +1 | +1 | +1 | −1 |
| 1009 | 1 | 2 | +1 | −1 | +1 | −1 |
| 1010 | 2 | 4 | +1 | +1 | +1 | −1 |
| 1011 | 2 | 4 | +1 | −1 | +1 | −1 |

Antenna port indication tables: The downlink control information (DCI) contains a bit field that selects which antenna ports and the number of antenna ports (i.e., the number of data layers) is scheduled. For example, if port 1000 is indicated, then the PDSCH is a single layer transmission and the UE will use the DMRS defined by port 1000 to demodulate the PDSCH.

An example is shown in Table 3 below for DMRS Type 1 and with a single front loaded DMRS symbol (maxLength=1). The DCI indicates a value and the number of DMRS ports. The value indicated in DCI also indicates the number of CDM groups without data. If one CDM group without data is indicated, then the REs for the other CDM group without DMRS will be used for PDSCH. If two CDM groups without data is indicated, both CDM groups may contain DMRS and no data is mapped to the OFDM symbol contains the DMRS.

For DMRS Type 1, ports 1000 and 1001 are in CDM group λ=0 and ports 1002 and 1003 are in CDM group λ=1. When two front-load symbols are configured, two additional DMRS ports are available in each CDM group.

Table 4 shows the corresponding table for DMRS Type 2 with a single front-load DMRS symbol.

For DMRS Type 2 ports 1000 and 1001 are in CDM group λ=0 and ports 1002 and 1003 are in CDM group λ=1. Ports 1004 and 1005 are in CDM group λ=2. When two front-load symbols are configured, two additional DMRS ports are available in each CDM group. This is also indicated in Table 2.

Table 5 and Table 6 are the antenna port mapping tables for DMRS with up to two front-loaded symbols.

TABLE 2-4
Antenna port(s) (1000 + DMRS port), dmrs-Type = 1, maxLength = 1
One Codeword:
Codeword 0 enabled,
Codeword 1 disabled

| | Number of | |
|---|---|---|
| | DMRS CDM | |
| | group(s) | |
| | without | DMRS |
| Value | data | port(s) |
| 0 | 1 | 0 |
| 1 | 1 | 1 |
| 2 | 1 | 0, 1 |
| 3 | 2 | 0 |
| 4 | 2 | 1 |
| 5 | 2 | 2 |
| 6 | 2 | 3 |
| 7 | 2 | 0, 1 |
| 8 | 2 | 2, 3 |
| 9 | 2 | 0-2 |
| 10 | 2 | 0-3 |
| 11 | 2 | 0, 2 |
| 12-15 | Reserved | Reserved |

TABLE 2-5
Antenna port(s) (1000 + DMRS port), dmrs-
Type = 2, maxLength = 1

| One codeword: | | | Two codewords: | | |
|---|---|---|---|---|---|
| Codeword 0 enabled, | | | Codeword 0 enabled, | | |
| Codeword 1 disabled | | | Codeword 1 enabled | | |
| | Number of | | | Number of | |
| | DMRS CDM | | | DMRS CDM | |
| | group(s) | | | group(s) | |
| | without | DMRS | | without | DMRS |
| Value | data | port(s) | Value | data | port(s) |
| 0 | 1 | 0 | 0 | 3 | 0-4 |
| 1 | 1 | 1 | 1 | 3 | 0-5 |
| 2 | 1 | 0, 1 | 2-31 | reserved | reserved |
| 3 | 2 | 0 | | | |
| 4 | 2 | 1 | | | |
| 5 | 2 | 2 | | | |
| 6 | 2 | 3 | | | |
| 7 | 2 | 0, 1 | | | |
| 8 | 2 | 2, 3 | | | |
| 9 | 2 | 0-2 | | | |
| 10 | 2 | 0-3 | | | |
| 11 | 3 | 0 | | | |
| 12 | 3 | 1 | | | |
| 13 | 3 | 2 | | | |
| 14 | 3 | 3 | | | |
| 15 | 3 | 4 | | | |
| 16 | 3 | 5 | | | |
| 17 | 3 | 0, 1 | | | |
| 18 | 3 | 2, 3 | | | |
| 19 | 3 | 4, 5 | | | |
| 20 | 3 | 0-2 | | | |
| 21 | 3 | 3-5 | | | |
| 22 | 3 | 0-3 | | | |
| 23 | 2 | 0, 2 | | | |
| 24-31 | Reserved | Reserved | | | |

TABLE 2-6
Antenna port(s) (1000 + DMRS port), dmrs-Type = 1,
maxLength = 2

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number | | | | Number | | |
| | of DMRS | | | | of DMRS | | |
| | CDM | | Number | | CDM | | Number |
| | group(s) | | of front- | | group(s) | | of front- |
| | without | DMRS | load | | without | | load |
| Value | data | port(s) | symbols | Value | data | DMRS port(s) | symbols |
| 0 | 1 | 0 | 1 | 0 | 2 | 0-4 | 2 |
| 1 | 1 | 1 | 1 | 1 | 2 | 0,1,2,3,4,6 | 2 |
| 2 | 1 | 0, 1 | 1 | 2 | 2 | 0,1,2,3,4,5,6 | 2 |
| 3 | 2 | 0 | 1 | 3 | 2 | 0,1,2,3,4,5,6,7 | 2 |
| 4 | 2 | 1 | 1 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | Reserved | Reserved | Reserved | | | | |

TABLE 2-7
Antenna port(s) (1000 + DMRS port), dmrs-Type = 2,
maxLength = 2

| One codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number | | | | Number | | |
| | of DMRS | | | | of DMRS | | |
| | CDM | | Number | | CDM | | Number |
| | group(s) | | of | | group(s) | | of front- |
| | without | DMRS | front- | | without | | load |
| Value | data | port(s) | load | Value | data | DMRS port(s) | symbols |
| 0 | 1 | 0 | 1 | 0 | 3 | 0-4 | 1 |
| 1 | 1 | 1 | 1 | 1 | 3 | 0-5 | 1 |
| 2 | 1 | 0, 1 | 1 | 2 | 2 | 0, 1, 2, 3, 6 | 2 |
| 3 | 2 | 0 | 1 | 3 | 2 | 0, 1, 2, 3, 6, 8 | 2 |
| 4 | 2 | 1 | 1 | 4 | 2 | 0, 1, 2, 3, 6, 7, 8 | 2 |
| 5 | 2 | 2 | 1 | 5 | 2 | 0, 1, 2, 3, 6, 7, 8, 9 | 2 |
| 6 | 2 | 3 | 1 | 6-63 | Reserved | Reserved | Reserved |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 3 | 0 | 1 | | | | |
| 12 | 3 | 1 | 1 | | | | |
| 13 | 3 | 2 | 1 | | | | |
| 14 | 3 | 3 | 1 | | | | |
| 15 | 3 | 4 | 1 | | | | |
| 16 | 3 | 5 | 1 | | | | |
| 17 | 3 | 0, 1 | 1 | | | | |
| 18 | 3 | 2, 3 | 1 | | | | |
| 19 | 3 | 4, 5 | 1 | | | | |
| 20 | 3 | 0-2 | 1 | | | | |
| 21 | 3 | 3-5 | 1 | | | | |
| 22 | 3 | 0-3 | 1 | | | | |
| 23 | 2 | 0, 2 | 1 | | | | |
| 24 | 3 | 0 | 2 | | | | |
| 25 | 3 | 1 | 2 | | | | |
| 26 | 3 | 2 | 2 | | | | |
| 27 | 3 | 3 | 2 | | | | |
| 28 | 3 | 4 | 2 | | | | |
| 29 | 3 | 5 | 2 | | | | |
| 30 | 3 | 6 | 2 | | | | |
| 31 | 3 | 7 | 2 | | | | |
| 32 | 3 | 8 | 2 | | | | |
| 33 | 3 | 9 | 2 | | | | |
| 34 | 3 | 10 | 2 | | | | |
| 35 | 3 | 11 | 2 | | | | |
| 36 | 3 | 0, 1 | 2 | | | | |
| 37 | 3 | 2, 3 | 2 | | | | |
| 38 | 3 | 4, 5 | 2 | | | | |
| 39 | 3 | 6, 7 | 2 | | | | |
| 40 | 3 | 8, 9 | 2 | | | | |
| 41 | 3 | 10, 11 | 2 | | | | |
| 42 | 3 | 0, 1, 6 | 2 | | | | |
| 43 | 3 | 2, 3, 8 | 2 | | | | |
| 44 | 3 | 4, 5, 10 | 2 | | | | |
| 45 | 3 | 0, 1, 6, 7 | 2 | | | | |
| 46 | 3 | 2, 3, 8, 9 | 2 | | | | |
| 47 | 3 | 4, 5, 10, 11 | 2 | | | | |
| 48 | 1 | 0 | 2 | | | | |
| 49 | 1 | 1 | 2 | | | | |
| 50 | 1 | 6 | 2 | | | | |
| 51 | 1 | 7 | 2 | | | | |
| 52 | 1 | 0, 1 | 2 | | | | |
| 53 | 1 | 6, 7 | 2 | | | | |
| 54 | 2 | 0, 1 | 2 | | | | |
| 55 | 2 | 2, 3 | 2 | | | | |
| 56 | 2 | 6, 7 | 2 | | | | |
| 57 | 2 | 8, 9 | 2 | | | | |

Mapping between TCI states and DMRS CDM groups: It has been agreed in 3GPP that each CDM group can be mapped to only one TCI state. In case two TCI states are indicated in a DCI and DMRS ports in two CDM groups are signaled, the first TCI state is mapped to the first CDM group and the second TCI state is mapped to the second CDM group. In case of Type 2 and DMRS ports in three CDM groups are indicated in the DCI, then the mapping is still to be determined in 3GPP.

There currently exist certain challenges. In the case of the two types of FDM schemes (i.e., single codeword-single RV scheme, and multiple codewords-multiple RVs scheme), a single PDSCH will be scheduled by a single DCI in a slot. Hence, in the case of both schemes the Frequency Domain Resource Allocation field in DCI may provide the aggregate of PRBs used by both TRPs. Hence, the TBS determination in Rel-15 NR cannot be directly applied for both FDM schemes. Systems and methods for determining TBS are needed.

### SUMMARY

Systems and methods for determining Transport Block Size (TBS) are provided. In some embodiments, a method performed by a wireless device for determining (TBS) includes: receiving an indication of the type of Frequency Domain Multiplexing (FDM) scheme from a base station; and applying different rules to determine TBS depending on which type of FDM scheme was indicated. In this way, different rules of how to determine TBS are provided when both flavors (i.e., single codeword-single Redundancy Version (RV) scheme, and multiple codewords-multiple RVs scheme) of FDM schemes are supported by NR Rel-16.

Certain aspects of the present disclosure and their embodiments may provide solutions to the aforementioned or other challenges. To address the open issue of how to determine TBS for the FDM schemes with single codeword-single RV and multiple codewords-multiple RVs, a solution is proposed that involves
The UE receiving an indication of the type of FDM scheme from the gNB
The UE applying different rules to determine TBS depending on which type of FDM scheme was indicated

In the proposed solution, the Rel-15 TBS determination is used when the single codeword-single RV FDM scheme is indicated. In the case that multiple codeword-multiple RV FDM scheme is indicated, it is proposed that the UE uses only the PRBs corresponding to the first codeword with the first RV for TBS determination.

There are, proposed herein, various embodiments which address one or more of the issues disclosed herein. In some embodiments, a method performed by a wireless device for determining TBS includes at least one of: receiving an indication of the type of FDM scheme from a network node; and applying different rules to determine TBS depending on which type of FDM scheme was indicated.

In some embodiments, when a single codeword-single RV FDM scheme is indicated, using Rel-15 TBS to determine TBS. In some embodiments, when a multiple codeword-multiple RV FDM scheme is indicated, using only the PRBs corresponding to the first codeword with the first RV to determine TBS.

In some embodiments, receiving the indication of the type of FDM scheme comprises receiving a higher layer configuration of which FDM scheme is being used. In some embodiments, receiving the indication of the type of FDM scheme comprises receiving an indication via one or more DCI fields of which FDM scheme is being used.

In some embodiments, a TCI field and a RV field are used to indicate which FDM scheme is being used. In some embodiments, the TCI field and the Antenna ports field are used to indicate which FDM scheme is being used.

In some embodiments, the wireless device uses all the PRBs indicated for PDSCH scheduling for TBS determination if the indicated FDM scheme is the single codeword-single RV FDM scheme. In some embodiments, the wireless device uses only the PRBs corresponding to the first codeword with the first RV for TBS determination if the indicated FDM scheme is the multiple codeword-multiple RV FDM scheme. In some embodiments, the PRBs corresponding to the first codeword with the first RV are given by a first set among multiple sets of PRBs with the first set having a start PRB value and length of PRBs being allocated using a single frequency domain resource allocation field in DCI.

In some embodiments, the PRBs corresponding to the first codeword with the first RV are given by a first set among multiple sets of PRBs with the first set given by a first part of a single frequency domain resource allocation field in DCI. In some embodiments, the PRBs corresponding to the first codeword with the first RV are given by a first set among multiple sets of PRBs with the first set given by a first frequency domain resource allocation field among multiple frequency domain resource allocation fields in DCI.

In some embodiments, the wireless device operates in a NR communications network. In some embodiments, the network node is a gNB.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the first two symbols contain Physical Downlink Control Channel (PDCCH) and the remaining 12 symbols contain Physical Data Channels (PDCHs), either a Physical Downlink Shared Channel (PDSCH) or Physical Uplink Shared Channel (PUSCH);

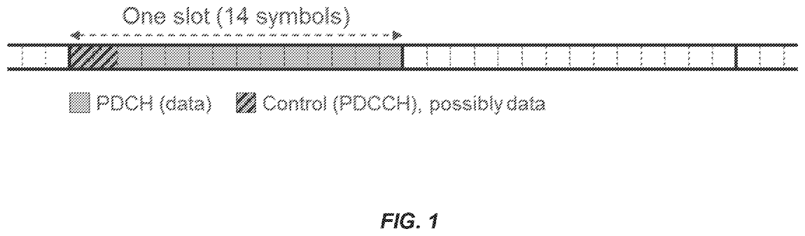

FIG. 2 illustrates the basic New Radio (NR) physical time-frequency resource grid where only one RB within a 14-symbol slot is shown;

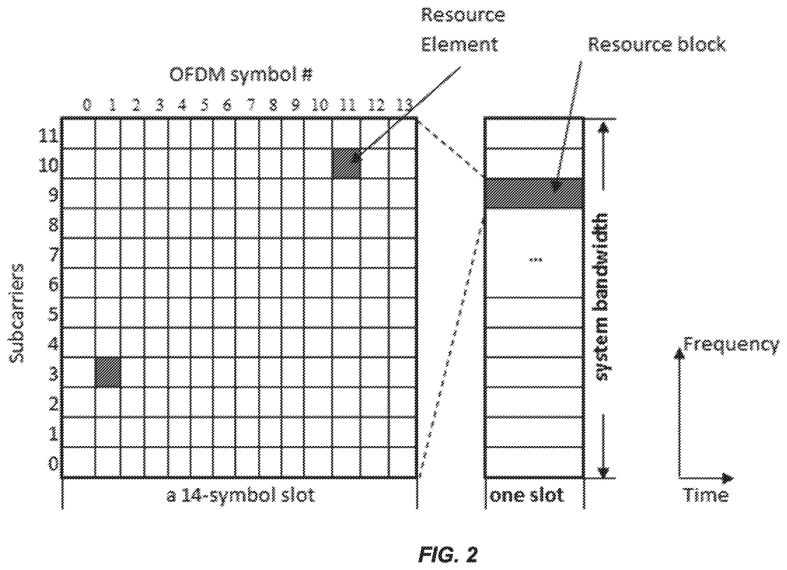

FIG. 3 illustrates the two PDSCHs carry the same encoded data payload but with the same or different redundancy versions so that the UE can do soft combining of the two PDSCHs to achieve more reliable reception;

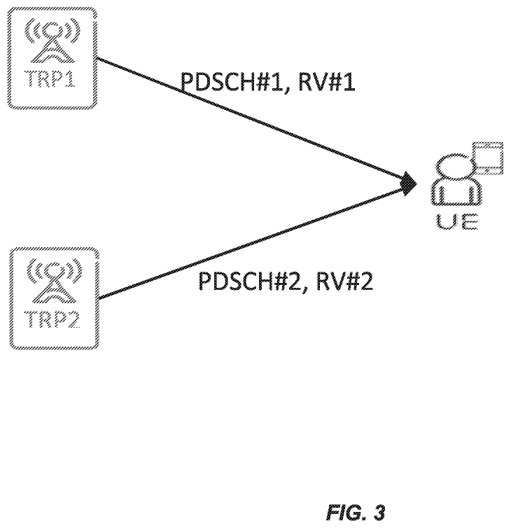

FIG. 4 illustrates four of the different TDM schemes;

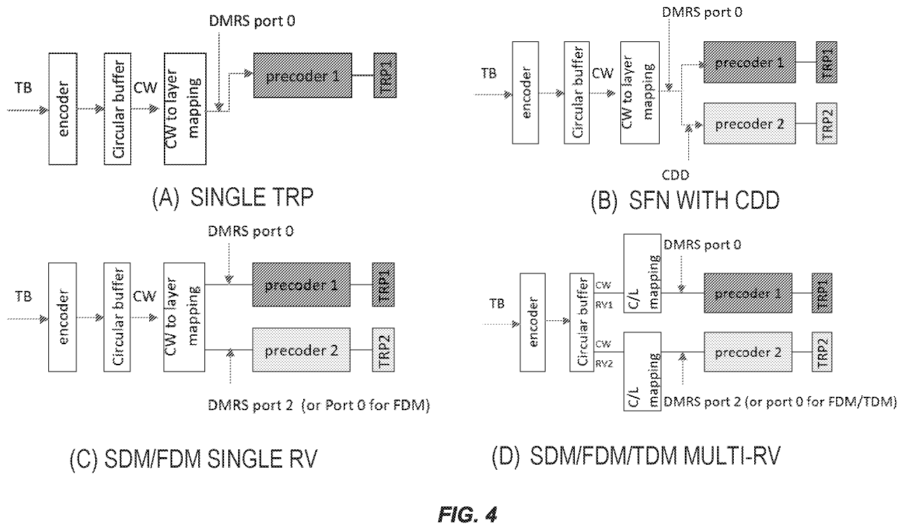

FIG. 5 illustrates four PDSCHs for a same Transport Block (TB) are transmitted over four TRPs and in four consecutive slots;

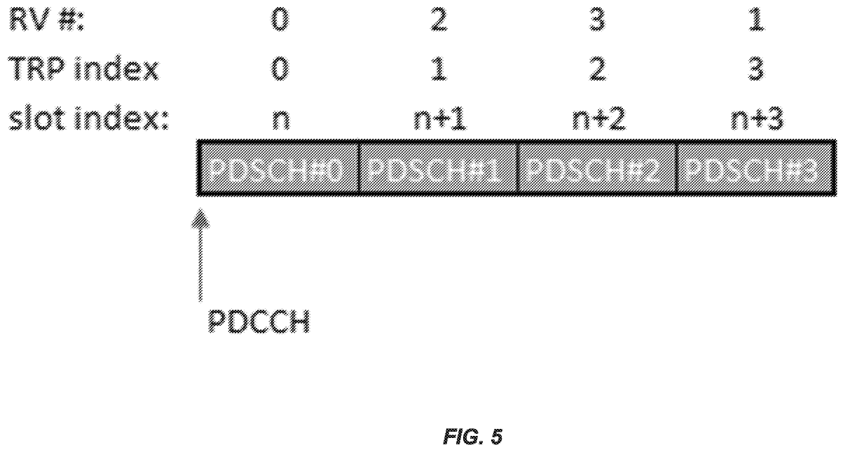

FIG. 6 shows an example of an SDM scheme with a single RV in which a PDSCH with two spatial layers, one from each TRP, is transmitted to a UE;

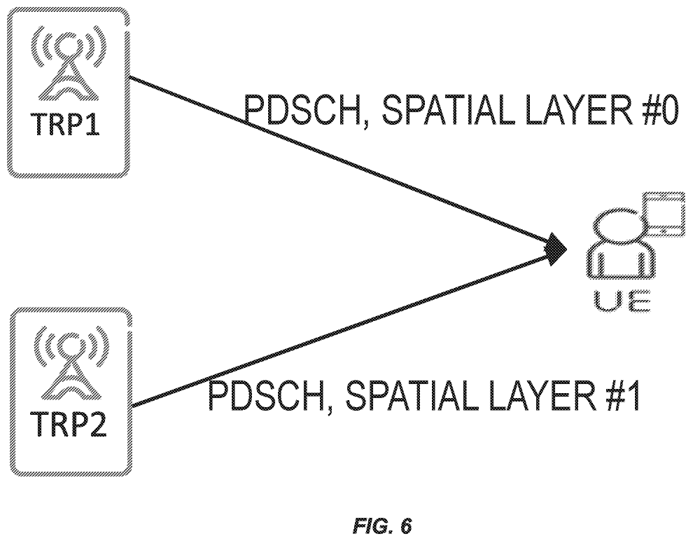

FIG. 7 shows an example of an FDM scheme in which a PDSCH is transmitted in RB #0, 1, 4, 5, 8, 9 from TRP1 and RB #2, 3, 6, 7, 10, 11 from TRP2;

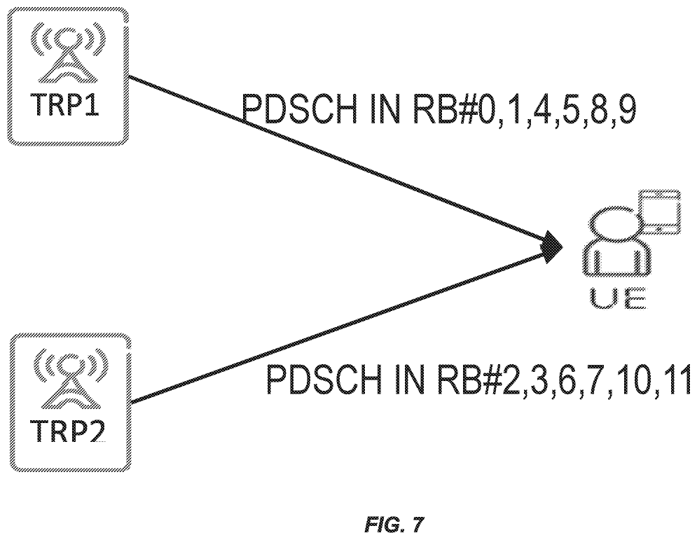

FIG. 8 shows an example of front-loaded DM-RS for configuration Type 1 and Type 2 with single-symbol and double-symbol DM-RS;

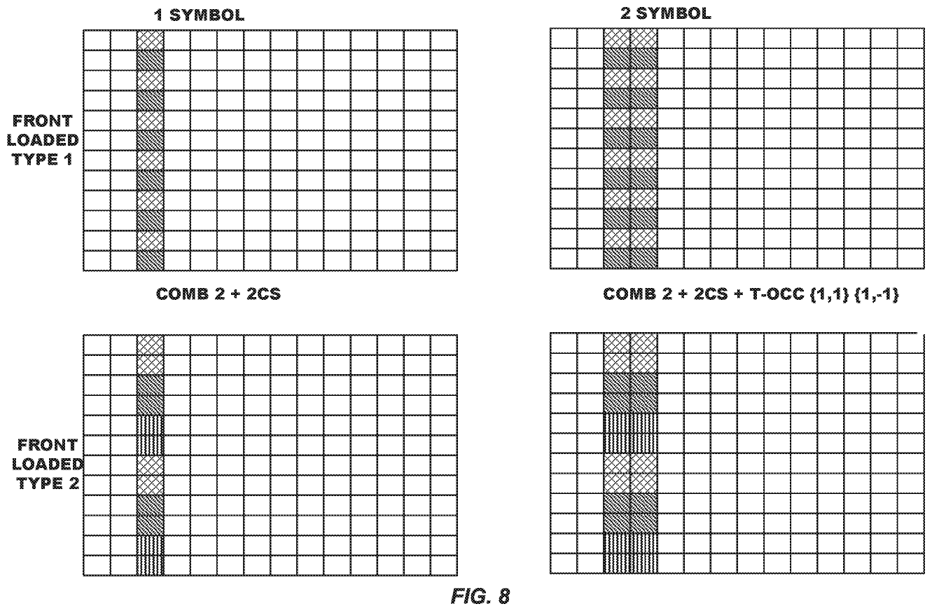

FIG. 9 illustrates one example of a cellular communications system in which embodiments of the present disclosure may be implemented;

FIG. 10 illustrates a wireless communication system represented as a 5G network architecture composed of core Network Functions (NFs), where interaction between any two NFs is represented by a point-to-point reference point/interface;

FIG. 11 illustrates a 5G network architecture using service-based interfaces between the NFs in the control plane, instead of the point-to-point reference points/interfaces used in the 5G network architecture of FIG. 10;

FIG. 12 shows an example of allocating PRBs to different codewords in the multiple codeword-multiple RV FDM scheme using resource allocation type 1 within a single Frequency Domain Resource Allocation Field;

FIG. 13 shows a second example of allocating PRBs to different codewords in the multiple codeword-multiple RV FDM scheme using resource allocation type 0 within a single Frequency Domain Resource Allocation Field;

FIG. 14 is a schematic block diagram of a radio access node according to some embodiments of the present disclosure;

FIG. 15 is a schematic block diagram that illustrates a virtualized embodiment of the radio access node according to some embodiments of the present disclosure;

FIG. 16 is a schematic block diagram of the radio access node according to some other embodiments of the present disclosure;

FIG. 17 is a schematic block diagram of a UE according to some embodiments of the present disclosure;

FIG. 18 is a schematic block diagram of the UE according to some other embodiments of the present disclosure;

FIGS. 19 and 20 illustrate examples of a cellular communications system, according to some embodiments of the present disclosure; and

FIGS. 21 through 24 are flowcharts illustrating methods implemented in a communication system, according to some embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless device.

Radio Access Node: As used herein, a “radio access node” or “radio network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a core network or any node that implements a core network function. Some examples of a core network node include, e.g., a Mobility Management Entity (MME), a Packet Data Network Gateway (PGW), a Service Capability Exposure Function (SCEF), a Home Subscriber Server (HSS), or the like. Some other examples of a core network node include a node implementing a Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Wireless Device: As used herein, a “wireless device” is any type of device that has access to (i.e., is served by) a cellular communications network by wirelessly transmitting and/or receiving signals to a radio access node(s). Some examples of a wireless device include, but are not limited to, a User Equipment device (UE) in a 3GPP network and a Machine Type Communication (MTC) device.

Network Node: As used herein, a “network node” is any node that is either part of the radio access network or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

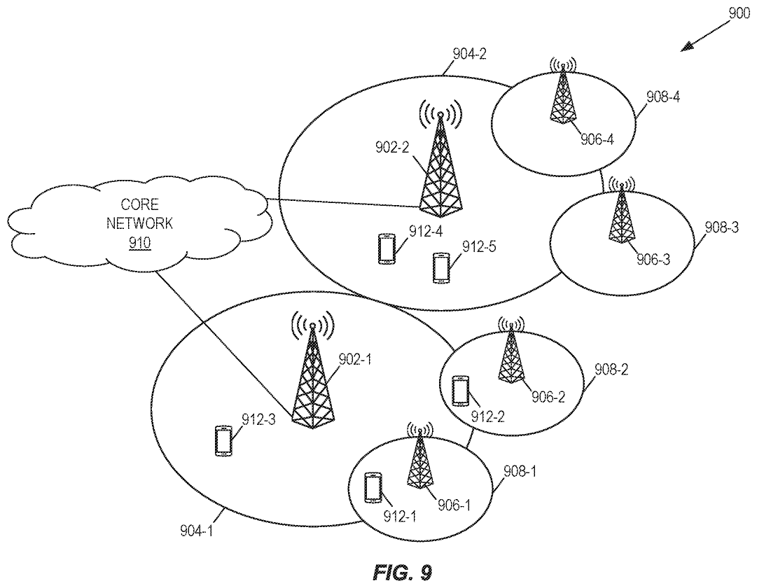

FIG. 9 illustrates one example of a cellular communications system 900 in which embodiments of the present disclosure may be implemented. In the embodiments described herein, the cellular communications system 900 is a 5G system (5GS) including a NR RAN or an Evolved Packet System (EPS) including a LTE RAN. In this example, the RAN includes base stations 902-1 and 902-2, which in LTE are referred to as eNBs and in 5G NR are referred to as gNBs, controlling corresponding (macro) cells 904-1 and 904-2. The base stations 902-1 and 902-2 are generally referred to herein collectively as base stations 902 and individually as base station 902. Likewise, the (macro) cells 904-1 and 904-2 are generally referred to herein collectively as (macro) cells 904 and individually as (macro) cell 904. The RAN may also include a number of low power nodes 906-1 through 906-4 controlling corresponding small cells 908-1 through 908-4. The low power nodes 906-1 through 906-4 can be small base stations (such as pico or femto base stations) or Remote Radio Heads (RRHs), or the like. Notably, while not illustrated, one or more of the small cells 908-1 through 908-4 may alternatively be provided by the base stations 902. The low power nodes 906-1 through 906-4 are generally referred to herein collectively as low power nodes 906 and individually as low power node 906. Likewise, the small cells 908-1 through 908-4 are generally referred to herein collectively as small cells 908 and individually as small cell 908. The cellular communications system 900 also includes a core network 910, which in the 5GS is referred to as the 5G core (5GC). The base stations 902 (and optionally the low power nodes 906) are connected to the core network 910.

The base stations 902 and the low power nodes 906 provide service to wireless devices 912-1 through 912-5 in the corresponding cells 904 and 908. The wireless devices 912-1 through 912-5 are generally referred to herein collectively as wireless devices 912 and individually as wireless device 912. The wireless devices 912 are also sometimes referred to herein as UEs.

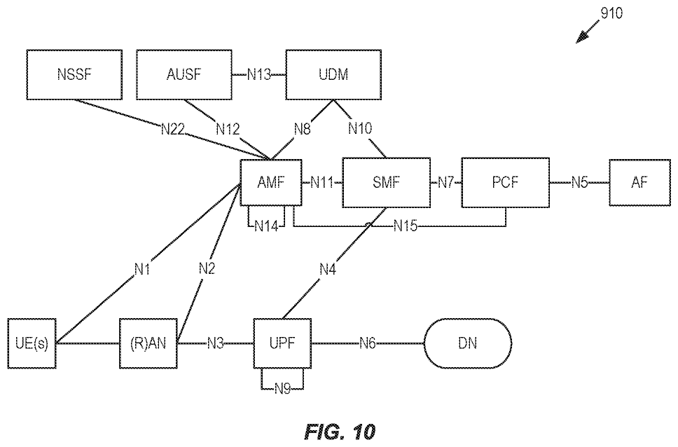

FIG. 10 illustrates a wireless communication system represented as a 5G network architecture composed of core Network Functions (NFs), where interaction between any two NFs is represented by a point-to-point reference point/interface. FIG. 10 can be viewed as one particular implementation of the system 900 of FIG. 9.

Seen from the access side the 5G network architecture shown in FIG. 10 comprises a plurality of User Equipment (UEs) connected to either a Radio Access Network (RAN) or an Access Network (AN) as well as an Access and Mobility Management Function (AMF). Typically, the (R)AN comprises base stations, e.g., such as evolved Node Bs (eNBs) or NR base stations (gNBs) or similar. Seen from the core network side, the 5G core NFs shown in FIG. 10 include a Network Slice Selection Function (NSSF), an Authentication Server Function (AUSF), a Unified Data Management (UDM), an AMF, a Session Management Function (SMF), a Policy Control Function (PCF), and an Application Function (AF).

Reference point representations of the 5G network architecture are used to develop detailed call flows in the normative standardization. The N1 reference point is defined to carry signaling between the UE and AMF. The reference points for connecting between the AN and AMF and between the AN and UPF are defined as N2 and N3, respectively. There is a reference point, N11, between the AMF and SMF, which implies that the SMF is at least partly controlled by the AMF. N4 is used by the SMF and UPF so that the UPF can be set using the control signal generated by the SMF, and the UPF can report its state to the SMF. N9 is the reference point for the connection between different UPFs, and N14 is the reference point connecting between different AMFs, respectively. N15 and N7 are defined since the PCF applies policy to the AMF and SMF, respectively. N12 is required for the AMF to perform authentication of the UE. N8 and N10 are defined because the subscription data of the UE is required for the AMF and SMF.

The 5G core network aims at separating user plane and control plane. The user plane carries user traffic while the control plane carries signaling in the network. In FIG. 10, the UPF is in the user plane and all other NFs, i.e., the AMF, SMF, PCF, AF, AUSF, and UDM, are in the control plane. Separating the user and control planes guarantees each plane resource to be scaled independently. It also allows UPFs to be deployed separately from control plane functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF and SMF are independent functions in the control plane. Separated AMF and SMF allow independent evolution and scaling. Other control plane functions like the PCF and AUSF can be separated as shown in FIG. 10. Modularized function design enables the 5G core network to support various services flexibly.

Each NF interacts with another NF directly. It is possible to use intermediate functions to route messages from one NF to another NF. In the control plane, a set of interactions between two NFs is defined as service so that its reuse is possible. This service enables support for modularity. The user plane supports interactions such as forwarding operations between different UPFs.

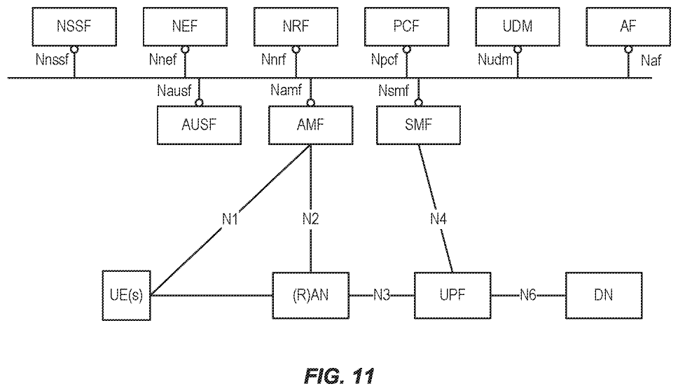

FIG. 11 illustrates a 5G network architecture using service-based interfaces between the NFs in the control plane, instead of the point-to-point reference points/interfaces used in the 5G network architecture of FIG. 10. However, the NFs described above with reference to FIG. 10 correspond to the NFs shown in FIG. 11. The service(s) etc. that a NF provides to other authorized NFs can be exposed to the authorized NFs through the service-based interface. In FIG. 11 the service based interfaces are indicated by the letter “N” followed by the name of the NF, e.g., Namf for the service based interface of the AMF and Nsmf for the service based interface of the SMF etc. The Network Exposure Function (NEF) and the Network Function (NF) Repository Function (NRF) in FIG. 11 are not shown in FIG. 10 discussed above. However, it should be clarified that all NFs depicted in FIG. 10 can interact with the NEF and the NRF of FIG. 11 as necessary, though not explicitly indicated in FIG. 10.

Some properties of the NFs shown in FIGS. 10 and 11 may be described in the following manner. The AMF provides UE-based authentication, authorization, mobility management, etc. A UE even using multiple access technologies is basically connected to a single AMF because the AMF is independent of the access technologies. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functionalities per session. The AF provides information on the packet flow to the PCF responsible for policy control in order to support Quality of Service (QoS). Based on the information, the PCF determines policies about mobility and session management to make the AMF and SMF operate properly. The AUSF supports authentication function for UEs or similar and thus stores data for authentication of UEs or similar while the UDM stores subscription data of the UE. The Data Network (DN), not part of the 5G core network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

There currently exist certain challenges. In the case of the two types of FDM schemes (i.e., single codeword-single RV scheme, and multiple codewords-multiple RVs scheme), a single PDSCH will be scheduled by a single DCI in a slot. Hence, in the case of both schemes the Frequency Domain Resource Allocation field in DCI may provide the aggregate of PRBs used by both TRPs. Hence, the TBS determination in Rel-15 NR cannot be directly applied for both FDM schemes. And, how to determine TBS for the FDM schemes with single codeword-single RV and multiple codewords-multiple RVs is an open problem. Systems and methods for determining TBS are needed.

Systems and methods for determining Transport Block Size (TBS) are provided. In some embodiments, a method performed by a wireless device (1700) for determining (TBS) includes: receiving an indication of the type of Frequency Domain Multiplexing (FDM) scheme from a base station (1400); and applying different rules to determine TBS depending on which type of FDM scheme was indicated. In this way, different rules of how to determine TBS are provided when both flavors (i.e., single codeword-single Redundancy Version (RV) scheme, and multiple codewords-multiple RVs scheme) of FDM schemes are supported by NR Rel-16.

In a general embodiment, the UE first receives an indication of which FDM scheme is used for PDSCH scheduling. In some embodiments, the indication may involve higher layer configuration of which FDM scheme is being used (for example, an RRC parameter may be configured to the UE which indicates whether the UE will receive PDSCH using the single codeword-single RV FDM scheme or the multiple codewords-multiple RVs FDM scheme). In other embodiments, the indication may be an indication via one or more DCI fields of which FDM scheme is being used. That is, semi-static indications applying to all scheduled PDSCHs associated with a PDSCH-Config are envisioned in addition to dynamic per-PDSCH indication. The following are some examples of indication via one or more DCI fields:
Example 1: if the TCI field in DCI indicates two TCI states and there are two RV values indicated (e.g., a sequence of 2 RVs indicated by the RV field) in DCI, then the UE assumes the muff/pie codewords-multiple RVs FDM scheme for PDSCH scheduling in a given slot. On the other hand, if the TCI field in DCI indicates two TCI states and there is a single RV value indicated in DCI, then the UE assumes the single codeword-single RV FDM scheme. That is, the FDM scheme used may be implicitly indicated based on the indicated number of RVs according to the interpretation of the RV field. Alternatively, if maximum two TBs are configured, the single codeword-single RV FDM scheme may be indicated when one TB is disabled in DCI Format 1-1 and two TCI states are indicated, and the multiple codewords-multiple RVs FDM scheme may be indicated when both TBs are enabled and two TCI states are indicated. That is, the FDM scheme may be implicitly indicated based how many TBs are enabled. In this case, the RV field for the first TB may be associated with the first TCI state and RV field for the second TB may be associated with the second TCI state.
Example 2: if the TCI field in DCI indicates two TCI states, then one of the fields in DCI can explicitly indicate which type of FDM scheme is being used. In one case, different codepoints in the Antenna Ports field in DCI may be used to indicate the type of FDM scheme. For example assuming DMRS type 1 with maximum length of 1 symbol, Antenna ports field values of 0-6 may be used to indicate single codeword-single RV FDM scheme while Antenna ports field values of 6-11 may be used to indicate multiple codewords-multiple RVs FDM scheme. Note that using Antenna Ports field to explicitly indicate the type of FDM schemes may need the definition of new DMRS tables compared to those presented in the background section.
Example 3: A new 1-bit DCI field may be introduced to explicitly indicate the FDM scheme.

Once the type of FDM scheme is determined, the UE applies different rules on how to determine the TBS for the different FDM schemes. The following rule can be applied for the different FDM schemes:
In the single codeword-single RV FDM scheme, all the PRBs indicated for PDSCH scheduling corresponds to a single TB as there is only one TB in this case. Hence, no change is needed compared to Rel-15 TBS determination and the Rel-15 NR TBS determination can be used for this type of FDM scheme. That is, the joint resource allocation corresponding to transmissions from all TRPs are taken into account when determining the TBS.
In the multiple codeword-multiple RV FDM scheme, all the PRBs indicated for PDSCH scheduling are split between the two codewords with the two codewords corresponding to different RVs of the same TB. Hence, all the PRBs indicated for PDSCH scheduling cannot be used in the TBS determination. One simple solution is to use only the PRBs corresponding to the first codeword with the first RV is used for TBS determination. In the next few sections, some details are provided on how to determine the PRBs corresponding to the first codeword with the first RV.

### Determination of the Number of PRBs to be Used for TBS Determination

Using separate frequency domain resource allocations

In the case multiple codeword-multiple RV FDM scheme is indicated to the UE, one approach is to indicate the PRBs to be used for both codewords using a single Frequency Domain Resource Allocation Field in DCI.

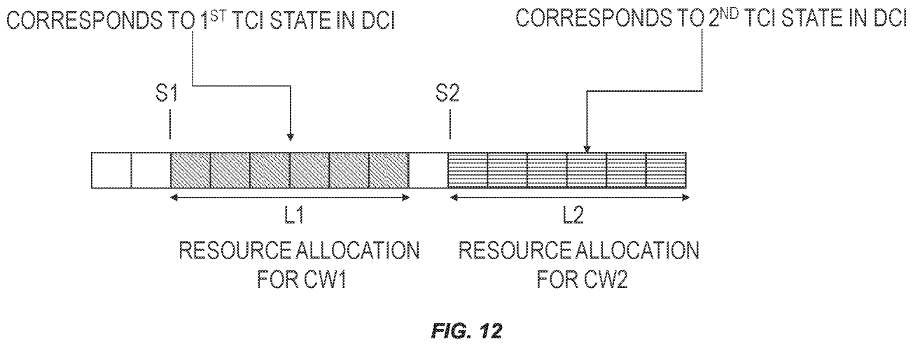

FIG. 12 shows an example of allocating PRBs to different codewords in the multiple codeword-multiple RV FDM scheme using resource allocation type 1 within a single Frequency Domain Resource Allocation Field. In this example, two starting PRBs (i.e., S1 and S2) and two lengths (i.e., L1 and L2) are indicated in the Frequency Domain Resource Allocation Field. The two sets of starting PRBs and lengths correspond to the two TCI states indicated by the TCI field in DCI. For the purposes of TBS determination, only the first set of PRBs with start S1 and length L1 are used for the purposes of TBS determination. The first set of PRBs in this example corresponds to the first codeword with the first RV.

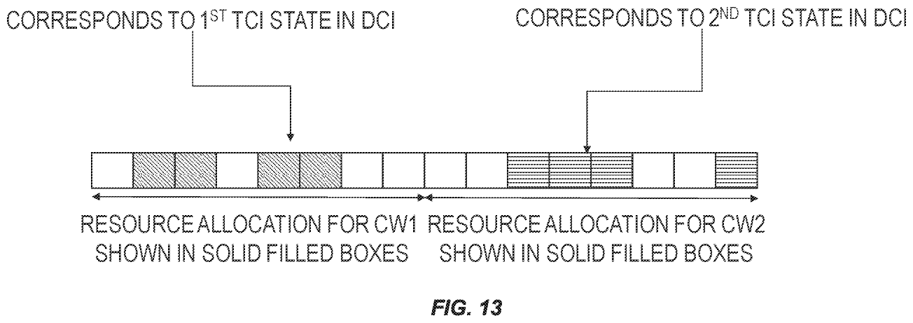

FIG. 13 shows a second example of allocating PRBs to different codewords in the multiple codeword-multiple RV FDM scheme using resource allocation type 0 within a single Frequency Domain Resource Allocation Field. In this example, the bits in the Frequency Domain Resource Allocation Field are split into two parts with the first part corresponding to resource allocation for the first codeword (which corresponds to the 1st TCI state indicated in DCI) and the second part corresponding to resource allocation for the second codeword (which corresponds to the 2nd TCI state indicated in DCI). For the purposes of TBS determination, only the first set of PRBs indicated for the first codeword with the first RV is used for the purposes of TBS determination.

In some other embodiments, two frequency domain resource allocation fields may be present in the DCI. In this case, each frequency domain resource allocation field will correspond to a different codeword. Hence, in this embodiment, for the purpose of determining TBS for the multiple codeword-multiple RV FDM scheme, only the PRBs indicated by the first field is used for TBS determination.

Using a Common Frequency Domain Resource Allocation

In another embodiment, a common aggregated frequency resource allocation is indicated using a single Frequency Domain Resource Allocation Field in DCI. For example, the resource allocation includes a single pair of starting RB index (n) and length (L) values. In the case that the multiple codeword-multiple RV FDM scheme is indicated to the UE, for TB size determination only half of the total allocated RBs in DCI is used for TB size calculation.

The UE first determines the number of REs allocated for PDSCH within a PRB (N′_{RE}) according to the Rel-15 procedure below:

N′_{RE}=N_{sc}^{RB}·N_{symb}^{sh}−N_{DMRS}^{PRB}−Nₒₕ^{PRB},

where N_{sc}^{RB}=12 is the number of subcarriers in a physical resource block, N_{symb}^{sh} is the number of symbols of the PDSCH allocation within the slot, N_{DMRS}^{PRB} is the number of REs for DM-RS per PRB in the scheduled duration including the overhead of the DM-RS CDM groups without data, as indicated by DCI format 1_1 or as described for format 1_0, and Nₒₕ^{RB} is the overhead configured by higher layer parameter xOverhead in PDSCH-ServingCellConfig. If the xOverhead in PDSCH-ServingCellconfig is not configured (a value from 0, 6, 12, or 18), the Nₒₕ^{PRB} is set to 0. If the PDSCH is scheduled by PDCCH with a Cyclic Redundancy Check scrambled by System Information-Radio Network Temporary Identifier (RNTI), Random Access-RNTI or Paging-RNTI, Nₒₕ^{PRB} is assumed to be 0.

The UE then determines the total number of REs allocated for PDSCH (N_{RE}) by N_{RE}=min(156, N′_{RE})·n_{PRB}/2, where n_{PRB} is the total number of allocated PRBs for the UE in DCI. The UE then follows the Rel-15 procedure in TS38.214 section 5.3.1.2 in determining the TB size.

The partition of the allocated RBs between two TRPs (associated with the two TCI states) can be predefined. In one example, the RBs may be interleaved between two TRPs with certain granularity such as RB group (RBG) or Precoding Resource Block Group (PRG) starting from the first TRP on the first allocated RB.

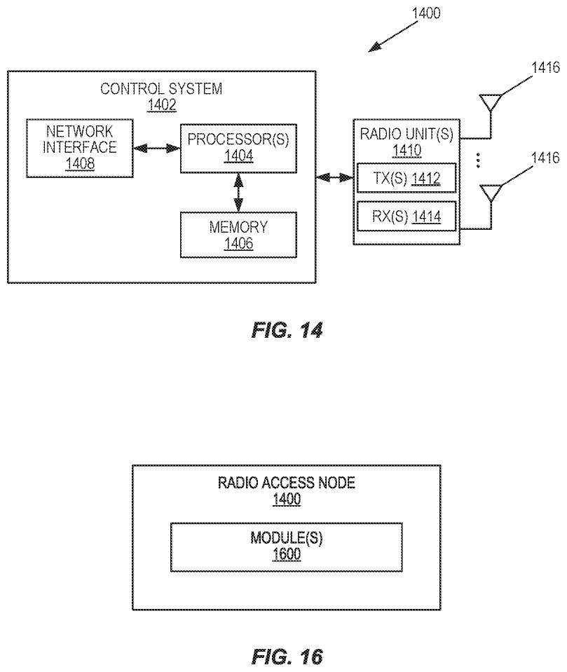

FIG. 14 is a schematic block diagram of a radio access node 1400 according to some embodiments of the present disclosure. The radio access node 1400 may be, for example, a base station 902 or 906. As illustrated, the radio access node 1400 includes a control system 1402 that includes one or more processors 1404 (e.g., Central Processing Units (CPUs), Application Specific Integrated Circuits (ASICs), Field Programmable Gate Arrays (FPGAs), and/or the like), memory 1406, and a network interface 1408. The one or more processors 1404 are also referred to herein as processing circuitry. In addition, the radio access node 1400 includes one or more radio units 1410 that each includes one or more transmitters 1412 and one or more receivers 1414 coupled to one or more antennas 1416. The radio units 1410 may be referred to or be part of radio interface circuitry. In some embodiments, the radio unit(s) 1410 is external to the control system 1402 and connected to the control system 1402 via, e.g., a wired connection (e.g., an optical cable). However, in some other embodiments, the radio unit(s) 1410 and potentially the antenna(s) 1416 are integrated together with the control system 1402. The one or more processors 1404 operate to provide one or more functions of a radio access node 1400 as described herein. In some embodiments, the function(s) are implemented in software that is stored, e.g., in the memory 1406 and executed by the one or more processors 1404.

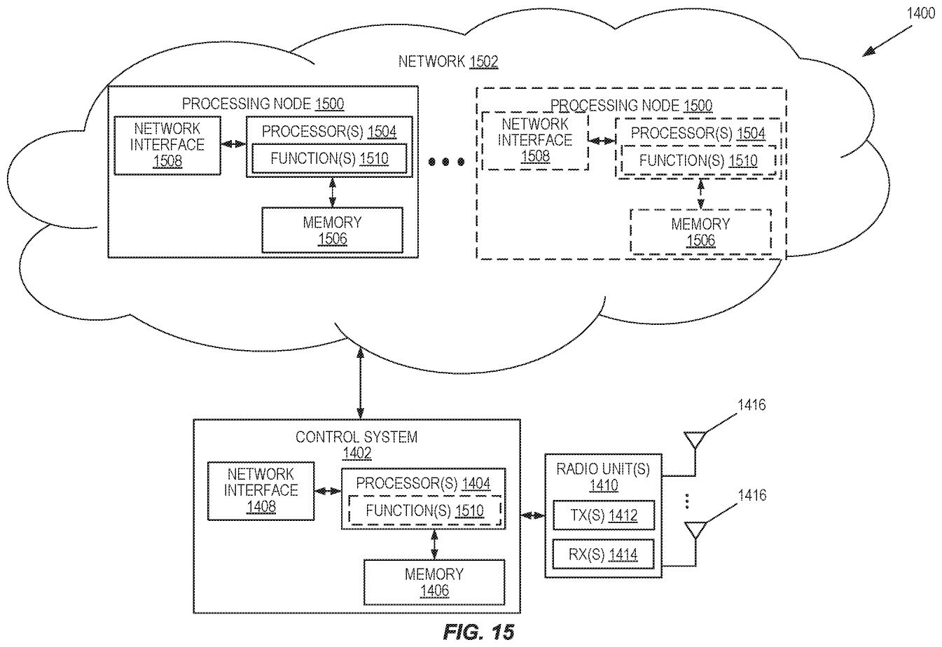

FIG. 15 is a schematic block diagram that illustrates a virtualized embodiment of the radio access node 1400 according to some embodiments of the present disclosure. This discussion is equally applicable to other types of network nodes. Further, other types of network nodes may have similar virtualized architectures.

As used herein, a “virtualized” radio access node is an implementation of the radio access node 1400 in which at least a portion of the functionality of the radio access node 1400 is implemented as a virtual component(s) (e.g., via a virtual machine(s) executing on a physical processing node(s) in a network(s)). As illustrated, in this example, the radio access node 1400 includes the control system 1402 that includes the one or more processors 1404 (e.g., CPUs, ASICs, FPGAs, and/or the like), the memory 1406, and the network interface 1408 and the one or more radio units 1410 that each includes the one or more transmitters 1412 and the one or more receivers 1414 coupled to the one or more antennas 1416, as described above. The control system 1402 is connected to the radio unit(s) 1410 via, for example, an optical cable or the like. The control system 1402 is connected to one or more processing nodes 1500 coupled to or included as part of a network(s) 1502 via the network interface 1408. Each processing node 1500 includes one or more processors 1504 (e.g., CPUs, ASICs, FPGAs, and/or the like), memory 1506, and a network interface 1508.

In this example, functions 1510 of the radio access node 1400 described herein are implemented at the one or more processing nodes 1500 or distributed across the control system 1402 and the one or more processing nodes 1500 in any desired manner. In some particular embodiments, some or all of the functions 1510 of the radio access node 1400 described herein are implemented as virtual components executed by one or more virtual machines implemented in a virtual environment(s) hosted by the processing node(s) 1500. As will be appreciated by one of ordinary skill in the art, additional signaling or communication between the processing node(s) 1500 and the control system 1402 is used in order to carry out at least some of the desired functions 1510. Notably, in some embodiments, the control system 1402 may not be included, in which case the radio unit(s) 1410 communicate directly with the processing node(s) 1500 via an appropriate network interface(s).

In some embodiments, a computer program including instructions which, when executed by at least one processor, causes the at least one processor to carry out the functionality of radio access node 1400 or a node (e.g., a processing node 1500) implementing one or more of the functions 1510 of the radio access node 1400 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

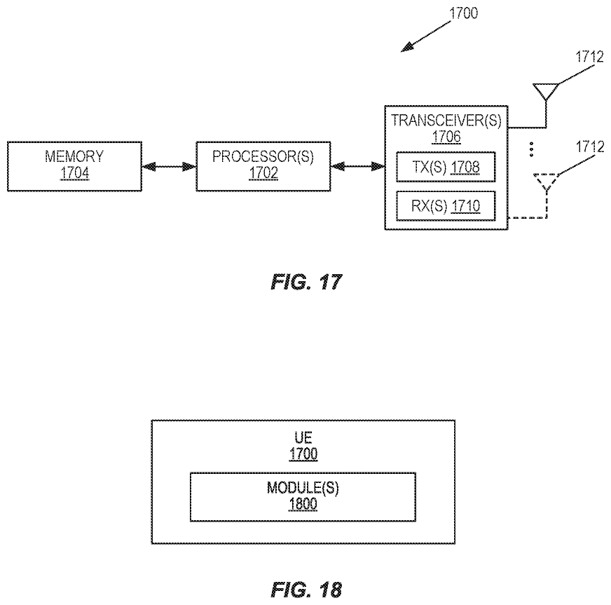

FIG. 16 is a schematic block diagram of the radio access node 1400 according to some other embodiments of the present disclosure. The radio access node 1400 includes one or more modules 1600, each of which is implemented in software. The module(s) 1600 provide the functionality of the radio access node 1400 described herein. This discussion is equally applicable to the processing node 1500 of FIG. 15 where the modules 1600 may be implemented at one of the processing nodes 1500 or distributed across multiple processing nodes 1500 and/or distributed across the processing node(s) 1500 and the control system 1402.

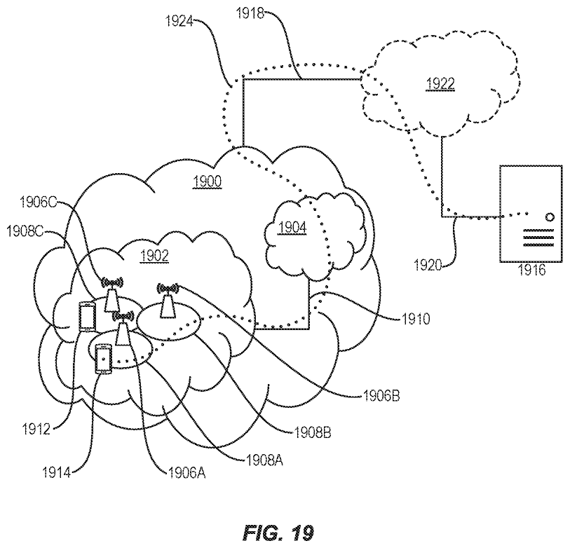

FIG. 17 is a schematic block diagram of a UE 1700 according to some embodiments of the present disclosure. As illustrated, the UE 1700 includes one or more processors 1702 (e.g., CPUs, ASICs, FPGAs, and/or the like), memory 1704, and one or more transceivers 1706 each including one or more transmitters 1708 and one or more receivers 1710 coupled to one or more antennas 1712. The transceiver(s) 1706 includes radio-front end circuitry connected to the antenna(s) 1712 that is configured to condition signals communicated between the antenna(s) 1712 and the processor(s) 1702, as will be appreciated by on of ordinary skill in the art. The processors 1702 are also referred to herein as processing circuitry. The transceivers 1706 are also referred to herein as radio circuitry. In some embodiments, the functionality of the UE 1700 described above may be fully or partially implemented in software that is, e.g., stored in the memory 1704 and executed by the processor(s) 1702. Note that the UE 1700 may include additional components not illustrated in FIG. 17 such as, e.g., one or more user interface components (e.g., an input/output interface including a display, buttons, a touch screen, a microphone, a speaker(s), and/or the like and/or any other components for allowing input of information into the UE 1700 and/or allowing output of information from the UE 1700), a power supply (e.g., a battery and associated power circuitry), etc.

In some embodiments, a computer program including instructions which, when executed by at least one processor, causes the at least one processor to carry out the functionality of the UE 1700 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

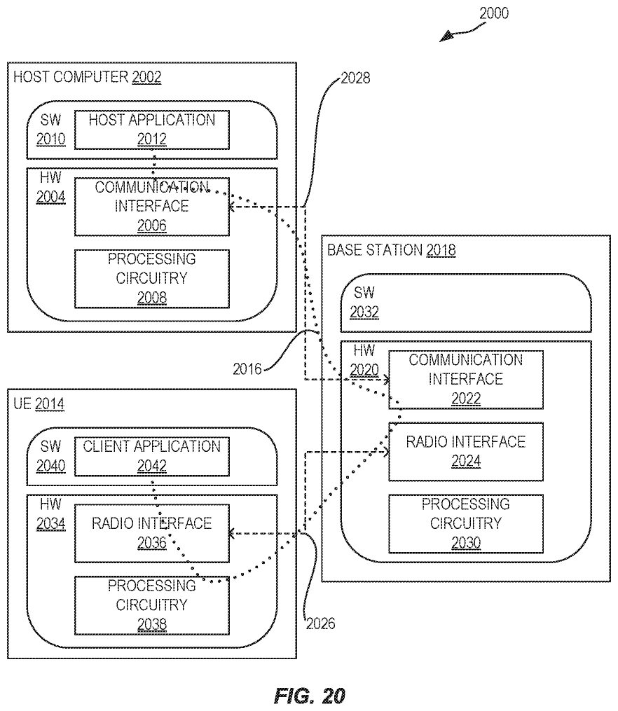

FIG. 18 is a schematic block diagram of the UE 1700 according to some other embodiments of the present disclosure. The UE 1700 includes one or more modules 1800, each of which is implemented in software. The module(s) 1800 provide the functionality of the UE 1700 described herein.

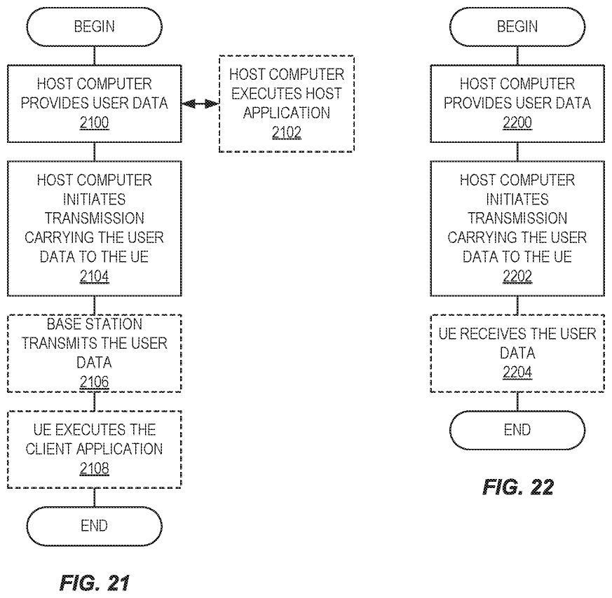

With reference to FIG. 19, in accordance with an embodiment, a communication system includes a telecommunication network 1900, such as a 3GPP-type cellular network, which comprises an access network 1902, such as a RAN, and a core network 1904. The access network 1902 comprises a plurality of base stations 1906A, 1906B, 1906C, such as Node Bs, eNBs, gNBs, or other types of wireless Access Points (APs), each defining a corresponding coverage area 1908A, 1908B, 1908C. Each base station 1906A, 1906B, 1906C is connectable to the core network 1904 over a wired or wireless connection 1910. A first UE 1912 located in coverage area 1908C is configured to wirelessly connect to, or be paged by, the corresponding base station 1906C. A second UE 1914 in coverage area 1908A is wirelessly connectable to the corresponding base station 1906A. While a plurality of UEs 1912, 1914 are illustrated in this example, the disclosed embodiments are equally applicable to a situation where a sole UE is in the coverage area or where a sole UE is connecting to the corresponding base station 1906.

The telecommunication network 1900 is itself connected to a host computer 1916, which may be embodied in the hardware and/or software of a standalone server, a cloud-implemented server, a distributed server, or as processing resources in a server farm. The host computer 1916 may be under the ownership or control of a service provider, or may be operated by the service provider or on behalf of the service provider. Connections 1918 and 1920 between the telecommunication network 1900 and the host computer 1916 may extend directly from the core network 1904 to the host computer 1916 or may go via an optional intermediate network 1922. The intermediate network 1922 may be one of, or a combination of more than one of, a public, private, or hosted network; the intermediate network 1922, if any, may be a backbone network or the Internet; in particular, the intermediate network 1922 may comprise two or more sub-networks (not shown).

The communication system of FIG. 19 as a whole enables connectivity between the connected UEs 1912, 1914 and the host computer 1916. The connectivity may be described as an Over-the-Top (OTT) connection 1924. The host computer 1916 and the connected UEs 1912, 1914 are configured to communicate data and/or signaling via the OTT connection 1924, using the access network 1902, the core network 1904, any intermediate network 1922, and possible further infrastructure (not shown) as intermediaries. The OTT connection 1924 may be transparent in the sense that the participating communication devices through which the OTT connection 1924 passes are unaware of routing of uplink and downlink communications. For example, the base station 1906 may not or need not be informed about the past routing of an incoming downlink communication with data originating from the host computer 1916 to be forwarded (e.g., handed over) to a connected UE 1912. Similarly, the base station 1906 need not be aware of the future routing of an outgoing uplink communication originating from the UE 1912 towards the host computer 1916.

Example implementations, in accordance with an embodiment, of the UE, base station, and host computer discussed in the preceding paragraphs will now be described with reference to FIG. 20. In a communication system 2000, a host computer 2002 comprises hardware 2004 including a communication interface 2006 configured to set up and maintain a wired or wireless connection with an interface of a different communication device of the communication system 2000. The host computer 2002 further comprises processing circuitry 2008, which may have storage and/or processing capabilities. In particular, the processing circuitry 2008 may comprise one or more programmable processors, ASICs, FPGAs, or combinations of these (not shown) adapted to execute instructions. The host computer 2002 further comprises software 2010, which is stored in or accessible by the host computer 2002 and executable by the processing circuitry 2008. The software 2010 includes a host application 2012. The host application 2012 may be operable to provide a service to a remote user, such as a UE 2014 connecting via an OTT connection 2016 terminating at the UE 2014 and the host computer 2002. In providing the service to the remote user, the host application 2012 may provide user data which is transmitted using the OTT connection 2016.

The communication system 2000 further includes a base station 2018 provided in a telecommunication system and comprising hardware 2020 enabling it to communicate with the host computer 2002 and with the UE 2014. The hardware 2020 may include a communication interface 2022 for setting up and maintaining a wired or wireless connection with an interface of a different communication device of the communication system 2000, as well as a radio interface 2024 for setting up and maintaining at least a wireless connection 2026 with the UE 2014 located in a coverage area (not shown in FIG. 20) served by the base station 2018. The communication interface 2022 may be configured to facilitate a connection 2028 to the host computer 2002. The connection 2028 may be direct or it may pass through a core network (not shown in FIG. 20) of the telecommunication system and/or through one or more intermediate networks outside the telecommunication system. In the embodiment shown, the hardware 2020 of the base station 2018 further includes processing circuitry 2030, which may comprise one or more programmable processors, ASICs, FPGAs, or combinations of these (not shown) adapted to execute instructions. The base station 2018 further has software 2032 stored internally or accessible via an external connection.

The communication system 2000 further includes the UE 2014 already referred to. The UE's 2014 hardware 2034 may include a radio interface 2036 configured to set up and maintain a wireless connection 2026 with a base station serving a coverage area in which the UE 2014 is currently located. The hardware 2034 of the UE 2014 further includes processing circuitry 2038, which may comprise one or more programmable processors, ASICs, FPGAs, or combinations of these (not shown) adapted to execute instructions. The UE 2014 further comprises software 2040, which is stored in or accessible by the UE 2014 and executable by the processing circuitry 2038. The software 2040 includes a client application 2042. The client application 2042 may be operable to provide a service to a human or non-human user via the UE 2014, with the support of the host computer 2002. In the host computer 2002, the executing host application 2012 may communicate with the executing client application 2042 via the OTT connection 2016 terminating at the UE 2014 and the host computer 2002. In providing the service to the user, the client application 2042 may receive request data from the host application 2012 and provide user data in response to the request data. The OTT connection 2016 may transfer both the request data and the user data. The client application 2042 may interact with the user to generate the user data that it provides.

It is noted that the host computer 2002, the base station 2018, and the UE 2014 illustrated in FIG. 20 may be similar or identical to the host computer 1916, one of the base stations 1906A, 1906B, 1906C, and one of the UEs 1912, 1914 of FIG. 19, respectively. This is to say, the inner workings of these entities may be as shown in FIG. 20 and independently, the surrounding network topology may be that of FIG. 19.

In FIG. 20, the OTT connection 2016 has been drawn abstractly to illustrate the communication between the host computer 2002 and the UE 2014 via the base station 2018 without explicit reference to any intermediary devices and the precise routing of messages via these devices. The network infrastructure may determine the routing, which may be configured to hide from the UE 2014 or from the service provider operating the host computer 2002, or both. While the OTT connection 2016 is active, the network infrastructure may further take decisions by which it dynamically changes the routing (e.g., on the basis of load balancing consideration or reconfiguration of the network).

The wireless connection 2026 between the UE 2014 and the base station 2018 is in accordance with the teachings of the embodiments described throughout this disclosure. One or more of the various embodiments improve the performance of OTT services provided to the UE 2014 using the OTT connection 2016, in which the wireless connection 2026 forms the last segment. More precisely, the teachings of these embodiments may improve the e.g., data rate, latency, power consumption, etc. and thereby provide benefits such as e.g., reduced user waiting time, relaxed restriction on file size, better responsiveness, extended battery lifetime, etc.

A measurement procedure may be provided for the purpose of monitoring data rate, latency, and other factors on which the one or more embodiments improve. There may further be an optional network functionality for reconfiguring the OTT connection 2016 between the host computer 2002 and the UE 2014, in response to variations in the measurement results. The measurement procedure and/or the network functionality for reconfiguring the OTT connection 2016 may be implemented in the software 2010 and the hardware 2004 of the host computer 2002 or in the software 2040 and the hardware 2034 of the UE 2014, or both. In some embodiments, sensors (not shown) may be deployed in or in association with communication devices through which the OTT connection 2016 passes; the sensors may participate in the measurement procedure by supplying values of the monitored quantities exemplified above, or supplying values of other physical quantities from which the software 2010, 2040 may compute or estimate the monitored quantities. The reconfiguring of the OTT connection 2016 may include message format, retransmission settings, preferred routing, etc.; the reconfiguring need not affect the base station 2018, and it may be unknown or imperceptible to the base station 2018. Such procedures and functionalities may be known and practiced in the art. In certain embodiments, measurements may involve proprietary UE signaling facilitating the host computer 2002's measurements of throughput, propagation times, latency, and the like. The measurements may be implemented in that the software 2010 and 2040 causes messages to be transmitted, in particular empty or ‘dummy’ messages, using the OTT connection 2016 while it monitors propagation times, errors, etc.

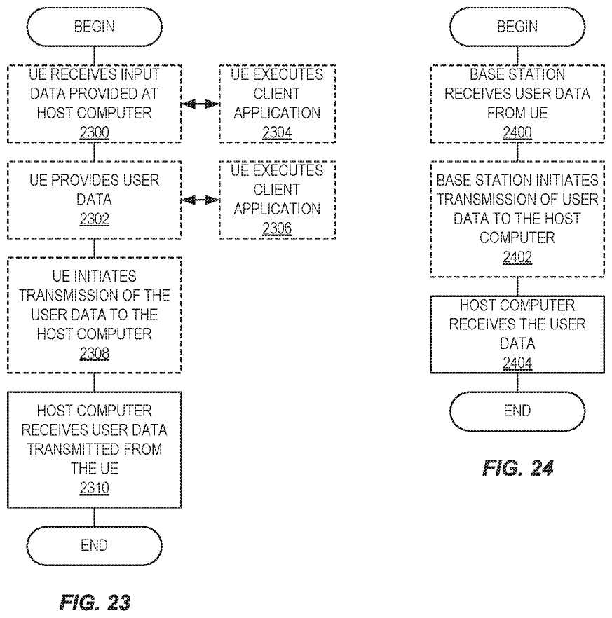

FIG. 21 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 21 will be included in this section. In step 2100, the host computer provides user data. In sub-step 2102 (which may be optional) of step 2100, the host computer provides the user data by executing a host application. In step 2104, the host computer initiates a transmission carrying the user data to the UE. In step 2106 (which may be optional), the base station transmits to the UE the user data which was carried in the transmission that the host computer initiated, in accordance with the teachings of the embodiments described throughout this disclosure. In step 2108 (which may also be optional), the UE executes a client application associated with the host application executed by the host computer.

FIG. 22 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 22 will be included in this section. In step 2200 of the method, the host computer provides user data. In an optional sub-step (not shown) the host computer provides the user data by executing a host application. In step 2202, the host computer initiates a transmission carrying the user data to the UE. The transmission may pass via the base station, in accordance with the teachings of the embodiments described throughout this disclosure. In step 2204 (which may be optional), the UE receives the user data carried in the transmission.

FIG. 23 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 23 will be included in this section. In step 2300 (which may be optional), the UE receives input data provided by the host computer. Additionally or alternatively, in step 2302, the UE provides user data. In sub-step 2304 (which may be optional) of step 2300, the UE provides the user data by executing a client application. In sub-step 2306 (which may be optional) of step 2302, the UE executes a client application which provides the user data in reaction to the received input data provided by the host computer. In providing the user data, the executed client application may further consider user input received from the user. Regardless of the specific manner in which the user data was provided, the UE initiates, in sub-step 2308 (which may be optional), transmission of the user data to the host computer. In step 2310 of the method, the host computer receives the user data transmitted from the UE, in accordance with the teachings of the embodiments described throughout this disclosure.

FIG. 24 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 24 will be included in this section. In step 2400 (which may be optional), in accordance with the teachings of the embodiments described throughout this disclosure, the base station receives user data from the UE. In step 2402 (which may be optional), the base station initiates transmission of the received user data to the host computer. In step 2404 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### EMBODIMENTS

### Group A Embodiments

Embodiment 1: A method performed by a wireless device for determining Transport Block Size, TBS, the method comprising at least one of: —receiving an indication of the type of Frequency Domain Multiplexing, FDM, scheme from a network node; and —applying different rules to determine TBS depending on which type of FDM scheme was indicated.

Embodiment 2: The method of embodiment 1 wherein, when a single codeword-single Redundancy Version, RV, FDM scheme is indicated, using Rel-15 TBS to determine TBS.

Embodiment 3: The method of any of embodiments 1 to 2 wherein, when a multiple codeword-multiple RV FDM scheme is indicated, using only the Physical Resource Blocks, PRBs, corresponding to the first codeword with the first RV to determine TBS.

Embodiment 4: The method of any of embodiments 1 to 3 wherein receiving the indication of the type of FDM scheme comprises receiving a higher layer configuration of which FDM scheme is being used.

Embodiment 5: The method of any of embodiments 1 to 4 wherein receiving the indication of the type of FDM scheme comprises receiving an indication via one or more Downlink Control Information, DCI, fields of which FDM scheme is being used.

Embodiment 6: The method of any of embodiments 1 to 5 wherein a Transmission Configuration Indicator, TCI, field and a RV field are used to indicate which FDM scheme is being used.

Embodiment 7: The method of any of embodiments 1 to 6 wherein the TCI field and the Antenna ports field are used to indicate which FDM scheme is being used.

Embodiment 8: The method of any of embodiments 1 to 7 wherein the wireless device uses all the PRBs indicated for PDSCH scheduling for TBS determination if the indicated FDM scheme is the single codeword-single RV FDM scheme.

Embodiment 9: The method of any of embodiments 1 to 8 wherein the wireless device uses only the PRBs corresponding to the first codeword with the first RV for TBS determination if the indicated FDM scheme is the multiple codeword-multiple RV FDM scheme.

Embodiment 10: The method of any of embodiments 1 to 9 wherein the PRBs corresponding to the first codeword with the first RV are given by a first set among multiple sets of PRBs with the first set having a start PRB value and length of PRBs being allocated using a single frequency domain resource allocation field in DCI.

Embodiment 11: The method of any of embodiments 1 to 10 wherein the PRBs corresponding to the first codeword with the first RV are given by a first set among multiple sets of PRBs with the first set given by a first part of a single frequency domain resource allocation field in DCI.

Embodiment 12: The method of any of embodiments 1 to 11 wherein the PRBs corresponding to the first codeword with the first RV are given by a first set among multiple sets of PRBs with the first set given by a first frequency domain resource allocation field among multiple frequency domain resource allocation fields in DCI.

Embodiment 13: The method of any of embodiments 1 to 12 wherein the wireless device operates in a New Radio, NR, communications network.

Embodiment 14: The method of any of embodiments 1 to 13 wherein the network node is a gNB.

Embodiment 15: The method of any of the previous embodiments, further comprising: providing user data; and forwarding the user data to a host computer via the transmission to the base station.

### Group B Embodiments

Embodiment 16: A method performed by a base station for determining Transport Block Size, TBS, the method comprising: applying different rules to determine TBS depending on which type of Frequency Domain Multiplexing, FDM, scheme is to be used; and transmitting an indication of the type of FDM scheme to a wireless device.

Embodiment 17: The method of embodiment 16 wherein, when a single codeword-single Redundancy Version, RV, FDM scheme is indicated, using Rel-15 TBS to determine TBS.

Embodiment 18: The method of any of embodiments 16 to 17 wherein, when a multiple codeword-multiple RV FDM scheme is indicated, using only the Physical Resource Blocks, PRBs, corresponding to the first codeword with the first RV to determine TBS.

Embodiment 19: The method of any of embodiments 16 to 18 wherein receiving the indication of the type of FDM scheme comprises receiving a higher layer configuration of which FDM scheme is being used.

Embodiment 20: The method of any of embodiments 16 to 19 wherein receiving the indication of the type of FDM scheme comprises receiving an indication via one or more Downlink Control Information, DCI, fields of which FDM scheme is being used.

Embodiment 21: The method of any of embodiments 16 to 20 wherein a Transmission Configuration Indicator, TCI, field and a RV field are used to indicate which FDM scheme is being used.

Embodiment 22: The method of any of embodiments 16 to 21 wherein the TCI field and the Antenna ports field are used to indicate which FDM scheme is being used.

Embodiment 23: The method of any of embodiments 16 to 22 wherein the wireless device uses all the PRBs indicated for PDSCH scheduling for TBS determination if the indicated FDM scheme is the single codeword-single RV FDM scheme.

Embodiment 24: The method of any of embodiments 16 to 23 wherein the wireless device uses only the PRBs corresponding to the first codeword with the first RV for TBS determination if the indicated FDM scheme is the multiple codeword-multiple RV FDM scheme.

Embodiment 25: The method of any of embodiments 16 to 24 wherein the PRBs corresponding to the first codeword with the first RV are given by a first set among multiple sets of PRBs with the first set having a start PRB value and length of PRBs being allocated using a single frequency domain resource allocation field in DCI.

Embodiment 26: The method of any of embodiments 16 to 25 wherein the PRBs corresponding to the first codeword with the first RV are given by a first set among multiple sets of PRBs with the first set given by a first part of a single frequency domain resource allocation field in DCI.

Embodiment 27: The method of any of embodiments 16 to 26 wherein the PRBs corresponding to the first codeword with the first RV are given by a first set among multiple sets of PRBs with the first set given by a first frequency domain resource allocation field among multiple frequency domain resource allocation fields in DCI.

Embodiment 28: The method of any of embodiments 16 to 27 wherein the base station operates in a New Radio, NR, communications network.

Embodiment 29: The method of any of embodiments 16 to 28 wherein the base station is a gNB.

Embodiment 30: The method of any of the previous embodiments, further comprising: obtaining user data; and forwarding the user data to a host computer or a wireless device.

### Group C Embodiments

Embodiment 31: A wireless device for determining Transport Block Size, TBS, the wireless device comprising: processing circuitry configured to perform any of the steps of any of the Group A embodiments; and power supply circuitry configured to supply power to the wireless device.

Embodiment 32: A base station for determining Transport Block Size, TBS, the base station comprising: processing circuitry configured to perform any of the steps of any of the Group B embodiments; and power supply circuitry configured to supply power to the base station.

Embodiment 33: A User Equipment, UE, for determining Transport Block Size, TBS, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 34: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Group B embodiments.

Embodiment 35: The communication system of the previous embodiment further including the base station.

Embodiment 36: The communication system of the previous 2 embodiments, further including the UE, wherein the UE is configured to communicate with the base station.

Embodiment 37: The communication system of the previous 3 embodiments, wherein: the processing circuitry of the host computer is configured to execute a host application, thereby providing the user data; and the UE comprises processing circuitry configured to execute a client application associated with the host application.

Embodiment 38: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.

Embodiment 39: The method of the previous embodiment, further comprising, at the base station, transmitting the user data.

Embodiment 40: The method of the previous 2 embodiments, wherein the user data is provided at the host computer by executing a host application, the method further comprising, at the UE, executing a client application associated with the host application.

Embodiment 41: A User Equipment, UE, configured to communicate with a base station, the UE comprising a radio interface and processing circuitry configured to perform the method of the previous 3 embodiments.

Embodiment 42: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Group A embodiments.

Embodiment 43: The communication system of the previous embodiment, wherein the cellular network further includes a base station configured to communicate with the UE.

Embodiment 44: The communication system of the previous 2 embodiments, wherein: the processing circuitry of the host computer is configured to execute a host application, thereby providing the user data; and the UE's processing circuitry is configured to execute a client application associated with the host application.

Embodiment 45: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of the Group A embodiments.

Embodiment 46: The method of the previous embodiment, further comprising at the UE, receiving the user data from the base station.

Embodiment 47: A communication system including a host computer comprising: communication interface configured to receive user data originating from a transmission from a User Equipment, UE, to a base station; wherein the UE comprises a radio interface and processing circuitry, the UE's processing circuitry configured to perform any of the steps of any of the Group A embodiments.

Embodiment 48: The communication system of the previous embodiment, further including the UE.

Embodiment 49: The communication system of the previous 2 embodiments, further including the base station, wherein the base station comprises a radio interface configured to communicate with the UE and a communication interface configured to forward to the host computer the user data carried by a transmission from the UE to the base station.

Embodiment 50: The communication system of the previous 3 embodiments, wherein: the processing circuitry of the host computer is configured to execute a host application; and the UE's processing circuitry is configured to execute a client application associated with the host application, thereby providing the user data.

Embodiment 51: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 52: A method implemented in a communication system including a host computer, a base station, and a User Equipment, UE, the method comprising: at the host computer, receiving user data transmitted to the base station from the UE, wherein the UE performs any of the steps of any of the Group A embodiments.

Embodiment 53: The method of the previous embodiment, further comprising, at the UE, providing the user data to the base station.

Embodiment 54: The method of the previous 2 embodiments, further comprising: at the UE, executing a client application, thereby providing the user data to be transmitted; and at the host computer, executing a host application associated with the client application.

Embodiment 55: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 56: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 57: The communication system of the previous embodiment further including the base station.

Embodiment 58: The communication system of the previous 2 embodiments, further including the UE, wherein the UE is configured to communicate with the base station.

Embodiment 59: The communication system of the previous 3 embodiments, wherein: the processing circuitry of the host computer is configured to execute a host application; and the UE is configured to execute a client application associated with the host application, thereby providing the user data to be received by the host computer.

Embodiment 60: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Group A embodiments.

Embodiment 61: The method of the previous embodiment, further comprising at the base station, receiving the user data from the UE.

Embodiment 62: The method of the previous 2 embodiments, further comprising at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Management Function
AN Access Network
AP Access Point
ASIC Application Specific Integrated Circuit
AUSF Authentication Server Function
CDD Cyclic Delay Diversity
CDM Code Division Multiplexing
CP Cyclic Prefix
CP-OFDM Cyclic Prefix Orthogonal Frequency Division Multiplexing
CPU Central Processing Unit
C-RNTI Cell Radio Network Temporary Identifier
CSI Channel State Information
CSI-RS Channel State Information Reference Signal
CW Codeword
DCI Downlink Channel Information
DFT Discrete Fourier Transform
DFT-S-OFDM DFT Spread OFDM
DL Downlink
DMRS Demodulation Reference Signal
DN Data Network
DSP Digital Signal Processor
eNB Enhanced or Evolved Node B
EPS Evolved Packet System
FDM Frequency Domain Multiplexing
FPGA Field Programmable Gate Array
FR Frequency Report
gNB New Radio Base Station
HSS Home Subscriber Service
IP Internet Protocol
IR Incremental Redundancy
LTE Long Term Evolution
MME Mobility Management Entity
MSB Most Significant Bit
MTC Machine Type Communication
NEF Network Exposure Function
NF Network Function
NR New Radio
NRF Network Function Repository Function
NSSF Network Slice Selection Function
OCC Orthogonal Cover Code
OFDM Orthogonal Frequency Division Multiplexing
OTT Over-the-Top
PCF Policy Control Function
PDCCH Physical Downlink Control Channel
PDCH Physical Data Channel
PDSCH Physical Downlink Shared Channel
P-GW Packet Data Network Gateway
PRG Precoding Resource Block Group
P-RNTI Paging Radio Network Temporary Identifier
PUCCH Physical Uplink Control Channel
PUSCH Physical Uplink Shared Channel
QCL Quasi Co-Located
QoS Quality of Service
RAM Random Access Memory
RAN Radio Access Network
RA-RNTI Random Access Radio Network Temporary Identifier
RB Resource Block
RBG Resource Block Group
RE Resource Element
RIV Resource Indication Value
RNTI Radio Network Temporary Identifier
ROM Read Only Memory
RRC Radio Resource Control
RRH Remote Radio Head
RS Reference Signal
RTT Round Trip Time
RV Redundancy Version
SCEF Service Capability Exposure Function
SCS Subcarrier Spacing
SCell Secondary Cell
SDM Spatial Division Multiplexing
SFN System Frame Number
S-GW Serving Gateway
SI-RNTI Scheduling Information Radio Network Temporary Identifier
SMF Session Management Function
SS Synchronization Signal
TB Transport Block
TBS Transport Block Size
TCI Transmission Configuration Indicator
TDM Time Domain Multiplexing
TRP Transmission/Reception Point
UDM Unified Data Management
UE User Equipment
UL Uplink
UPF User Plane Function
USB Universal Serial Bus
VRB Virtual Resource Blocks

Those skilled in the art will recognize improvements and modifications to the embodiments of the present disclosure. All such improvements and modifications are considered within the scope of the concepts disclosed herein.

1. A method performed by a wireless device for determining Transport Block Size, TBS, the method comprising:
receiving an indication of a type of multiplexing scheme for Physical Data Shared Channel, PDSCH, reception from a network; and
applying the TBS determination based on the indicated type of multiplexing scheme.

2. The method of claim 1 further comprising receiving the indication of the type of multiplexing scheme to be used via a higher layer configuration.

3. The method of claim 1 wherein, the indicated type of multiplexing scheme indicated comprises one among a plurality of Frequency Domain Multiplexing, FDM, schemes.

4. The method of claim 1 wherein receiving an indication of a type of FDM scheme comprises receiving an indication via one or more Downlink Control Information, DCI, fields of which FDM scheme of the plurality of FDM schemes is being used.

5. The method of claim 1 wherein a Transmission Configuration Indicator, TCI, field and a Redundancy Version, RV, field are used to indicate which FDM scheme of the plurality of FDM schemes is being used.

6. The method of claim 1 wherein the TCI field and an Antenna ports field are used to indicate which FDM scheme of the plurality of FDM schemes is being used.

7. The method of claim 1 wherein the wireless device uses Physical Resource Blocks, PRBs, indicated for PDSCH scheduling for TBS determination if the indicated FDM scheme of the plurality of FDM schemes is a single codeword-single RV FDM scheme.

8. The method of claim 7 wherein the single codeword-single RV FDM scheme is characterized by two Transmission Configuration Indication, TCI, states indicated in the TCI field in Downlink Control Information, DCI, and a single RV indicated in the RV field in the DCI.

9. The method of claim 1 wherein the wireless device uses only Physical Resource Blocks, PRBs, corresponding to a first codeword with a first Redundancy Version, RV, for TBS determination if the indicated FDM scheme of the plurality of FDM schemes is a multiple codeword-multiple RV FDM scheme.

10. The method of claim 9 wherein the multiple codeword-multiple RV FDM scheme is characterized by:
two Transmission Configuration Indication, TCI, states indicated in the TCI field in Downlink Control Information, DCI,
two RVs indicated in the RV field in the DCI, and
the first codeword and a second codeword corresponding to the same transport block, TB.

11. The method of claim 9 wherein the first codeword corresponds to a first TCI state indicated in the TCI field in the DCI.

12. The method of claim 1 wherein the PRBs corresponding to the first codeword with the first RV are given by a first set among multiple sets of the PRBs with the first set having a start PRB value and a length of PRBs being allocated using a single frequency domain resource allocation field in the DCI.

13. The method of claim 1 wherein the PRBs corresponding to the first codeword with the first RV are given by a first set among multiple sets of PRBs with the first set given by a first part of the single frequency domain resource allocation field in the DCI.

14. The method of claim 1 wherein the PRBs corresponding to the first codeword with the first RV are given by a first set among multiple sets of the PRBs with the first set given by a first frequency domain resource allocation field among multiple frequency domain resource allocation fields in the DCI.

15. The method of claim 1 wherein, the multiplexing scheme for PDSCH reception constitutes:
a first codeword corresponding to a first Transmission Configuration Indication, TCI, state among two TCI states indicated in a TCI field in Downlink Control Information, DCI, and a first Redundancy Version, RV, indicated in an RV field in the DCI,
a second codeword corresponding to a second TCI state among two TCI states indicated in the TCI field in the DCI and a second RV indicated in the RV field in the DCI, and
the first codeword and a second codeword correspond to a same transport block, TB.

16. The method of claim 1 wherein, the DCI indicates:
a first resource allocation corresponding to the first codeword constitutes a first starting allocation index and a first allocation length, and
a second resource allocation corresponding to the second codeword constitutes a second starting allocation index and a second allocation length.

17. The method of claim 1 wherein the wireless device uses only the first allocation length corresponding to the first codeword with the first RV for TBS determination.

18. The method of claim 1 wherein the wireless device operates in a New Radio, NR, communications network.

19. The method of claim 1 wherein the network is a gNB.

20. A method performed by a base station for determining Transport Block Size, TBS, the method comprising:
applying different rules to determine the TBS depending on an indicated type of Frequency Domain Multiplexing, FDM, scheme; and
transmitting the indication of the type of FDM scheme to a wireless device.

21. The method of claim 20 wherein, when a single codeword-single Redundancy Version, RV, FDM scheme is indicated, using a Rel-15 TBS to determine the TBS.

22. The method of claim 20 wherein, when a multiple codeword-multiple RV FDM scheme is indicated, using only Physical Resource Blocks, PRBs, corresponding to a first codeword with a first RV to determine the TBS.

23. The method of claim 20 wherein transmitting the indication of the type of FDM scheme comprises transmitting a higher layer configuration of the FDM scheme being used.

24. The method of claim 20 wherein transmitting the indication of the type of FDM scheme comprises transmitting an indication via one or more Downlink Control Information, DCI, fields of the FDM scheme being used.

25. The method of claim 20 wherein a Transmission Configuration Indicator, TCI, field and an RV field are used to indicate the FDM scheme being used.

26. The method of claim 20 wherein the TCI field and an Antenna ports field are used to indicate the FDM scheme being used.

27. The method of claim 20 wherein the base station uses all PRBs indicated for PDSCH scheduling for TBS determination if the indicated FDM scheme is the single codeword-single RV FDM scheme.

28. The method of claim 20 wherein the base station uses only the PRBs corresponding to the first codeword with the first RV for TBS determination if the indicated FDM scheme is the multiple codeword-multiple RV FDM scheme.

29. The method of claim 20 wherein the PRBs corresponding to the first codeword with the first RV are given by a first set among multiple sets of PRBs with the first set having a start PRB value and a length of PRBs being allocated using a single frequency domain resource allocation field in DCI.

30. The method of claim 20 wherein the PRBs corresponding to the first codeword with the first RV are given by the first set among multiple sets of PRBs with the first set given by a first part of a single frequency domain resource allocation field in DCI.

31. The method of claim 20 wherein the PRBs corresponding to the first codeword with the first RV are given by the first set among multiple sets of PRBs with the first set given by a first frequency domain resource allocation field among multiple frequency domain resource allocation fields in the DCI.

32. The method of claim 20 wherein the wireless device operates in a New Radio, NR, communications network.

33. The method of claim 20 wherein the base station is a gNB.

34. A wireless device comprising:
one or more processors; and
memory storing instructions executable by the one or more processors, whereby the wireless device is operable to:
receive an indication of a type of Frequency Domain Multiplexing, FDM, scheme from a base station; and
applying different rules to determine Transport Block Size, TBS, depending on the indicated type of FDM scheme.

35. (canceled)

36. A base station comprising:
one or more processors; and
memory storing instructions executable by the one or more processors, whereby the base station is operable to:
apply different rules to determine Transport Block Size, TBS, depending on an indicated type of multiplexing scheme; and
transmit an indication of the type of multiplexing scheme to a wireless device.

37. (canceled)
